(19) United States
(12) Patent Application Publication
(10) Pub. No.: US 2025/0046090 A1
(43) Pub. Date: Feb. 6, 2025

(54) NON-TRANSITORY RECORDING MEDIUM, BEHAVIOR STATE DETERMINATION SYSTEM, AND BEHAVIOR STATE DETERMINATION METHOD

(71) Applicant: Konica Minolta, Inc., Tokyo (JP)

(72) Inventor: Junichi FURUKAWA, Tokyo (JP)

(21) Appl. No.: 18/775,397

(22) Filed: Jul. 17, 2024

(30) Foreign Application Priority Data
Jul. 31, 2023 (JP) 2023-124115

(51) Int. Cl. G06V 20/52; G06T 7/70

(52) U.S. Cl. CPC G06V 20/53; G06T 7/70

(57) ABSTRACT

A non-transitory recording medium storing a computer readable program, the computer readable program is a behavior state determination program for determining a behavior state of a group of people present in a predetermined space, the behavior state determination program causing a computer to execute: dividing the group into a plurality of groups including at least a first group and a second group so as to satisfy the following relational formula [1]; extracting state information regarding each person in at least the first group and the second group divided in the dividing; and determining the behavior state of the group by comparing the state information extracted in the extracting with evaluation criterion information, 0.23≤x/w≤0.77 *** [1], where x is the number of people in the first group, and w is the total number of people in the space.

### CROSS-REFERENCE TO RELATED APPLICATION

The disclosure of Japanese Patent Application No. 2023-124115 filed on Jul. 31, 2023, including description, claims, drawings, and abstract, is incorporated herein by reference in its entirety.

### BACKGROUND OF THE INVENTION

### 1. Technical Field

The present invention relates to a non-transitory recording medium in which a behavior state determination program for causing a computer to execute processing of determining a behavior state of a group of people present in a predetermined space, such as participants of a lecture, a class, or a lecture meeting is recorded. The present invention further relates to a behavior state determination system and a behavior state determination method.

### 2. Description of Related art

It has been attempted to capture an image of a participant of a lecture, a lesson, a lecture meeting, or the like and analyze and evaluate the participant by image analysis.

As one of conventional techniques, Japanese Unexamined Patent Application Publication No. 2018-49481 discloses the following information processing apparatus. In the information processing apparatus, a behavior defined as an evaluation target in a predetermined evaluation item is extracted based on a part of a human body and a motion of the part detected from moving image data obtained by capturing images of a lecturer and a participant. Then, behaviors of the lecturer and the participant are evaluated in accordance with a predetermined evaluation criterion. Specifically, the degree to which the lecturer faces the participant in the lecture (the degree to which the lecturer pays attention to the participant) and the degree to which the participant faces the lecturer in the lecture (the degree to which the participant pays attention to the lecturer) are evaluated based on the level of the frequency of appearance and the length of the duration.

On the other hand, in recent years, traditional lecture styles have been reviewed, and more modern and advanced lecture styles have become popular. Specifically, a style in which a lecture is actively performed under the initiative of a participant (active learning) is adopted instead of a style in which a participant passively receives a lecture. More specifically, lecture styles such as group discussion and debate that a participant performs indoors, project learning, creative learning (practice and fieldwork), and sharing a study among a plurality of people are included. Furthermore, there are also lecture styles such as giving a lecture focusing on a plurality of units instead of giving a lecture directed to an individual, forming a group of about three to 6 people to perform collaborative work, and talking together after watching a video.

As described above, a style in which a lecture is actively performed under the initiative of a participant is widespread. For this reason, there is a demand for a method of appropriately evaluating the behavior states of participants, such as how much the participants face each other.

However, in the evaluation of the degree to which a lecturer and each participant face each other as indicated in Japanese Unexamined Patent Application Publication No. 2018-49481, it is not possible to appropriately evaluate how much the participants face each other.

### SUMMARY OF THE INVENTION

An object of the present invention is to provide a non-transitory recording medium having recorded thereon a computer readable behavior state determination program capable of causing a computer to execute processing of appropriately determining a behavior state of a group of people present in a predetermined space. As an example of the behavior state of the group of people present in the predetermined space, there is a state in which participants face each other in a lecture, a class, a lecture meeting, or the like.

Another object of the present invention is to provide a behavior state determination system and a behavior state determination method that can appropriately determine a behavior state of a group of people present in a predetermined space.

A first aspect of the present invention relates to a non-transitory recording medium storing a computer readable program, the computer readable program being a behavior state determination program for determining a behavior state of a group of people present in a predetermined space, the behavior state determination program causing a computer to execute: dividing the group into a plurality of groups including at least a first group and a second group so as to satisfy the following relational formula [1]; extracting state information regarding each person in at least the first group and the second group divided in the dividing; and determining the behavior state of the group by comparing the state information extracted in the extracting with evaluation criterion information,

$$0.23 \leq x / w \leq {0.77}^{** *} , \qquad [ 1 ]$$

where x is the number of people in the first group,
and w is the total number of people in the space.

A second aspect of the present invention relates to a behavior state determination system for determining a behavior state of a group of people present in a predetermined space, the behavior state determination system dividing the group into a plurality of groups including at least a first group and a second group so as to satisfy the following relational formula [1], extracting state information regarding each person in at least the first group and the second group divided in the dividing, and determining the behavior state of the group by comparing the extracted state information with evaluation criterion information,

$$0.23 \leq X / W \leq {0.77}^{** *} , \qquad [ 1 ]$$

where X is the number of people in the first group,
and W is the total number of people in the space.

A third aspect of the present invention relates to a behavior state determination method for determining a behavior state of a group of people present in a predetermined space by a behavior state determination system, the behavior state determination method including:
dividing the group into a plurality of groups including at least a first group and a second group so as to satisfy the following relational formula [1]; extracting state information regarding each person in at least the first group and the second group divided in the dividing; and determining the behavior state of the group by comparing the extracted state information with evaluation criterion information,

$$0.23 \leq X / W \leq {0.77}^{** *} , \qquad [ 1 ]$$

where X is the number of people in the first group,
and W is the total number of people in the space.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a diagram illustrating a configuration of a behavior state determination system according to an embodiment of the present invention;

FIG. 2 is a diagram illustrating examples A to L of a virtual participant group W;

FIG. 3 is similarly a diagram illustrating examples P to U of the virtual participant group W;

FIG. 4 is a diagram of a state in which the group illustrated in FIGS. 2 and 3 is divided by changing a manner of division;

FIG. 5 is similarly a diagram of a state in which the group illustrated in FIGS. 2 and 3 is divided by changing a manner of division;

FIG. 6 is a diagram illustrating an example of an evaluation criterion;

FIG. 7 is a diagram illustrating another example of the evaluation criterion;

FIG. 8 is a table illustrating results of Example 1;

FIG. 9 is a table illustrating results of Example 2;

FIG. 10 is a table illustrating results of Example 3;

FIG. 11 is a table illustrating results of Comparative Example 1;

FIG. 12 is a table illustrating results of Example 4;

FIG. 13 is a table illustrating results of Comparative Example 2;

FIG. 14 is a table illustrating results of Example 5;

FIG. 15 is a table illustrating results of Example 6;

FIG. 16 is a table illustrating results of Example 7;

FIG. 17 is a table illustrating results of Example 8;

FIG. 18 is a table illustrating results of Example 9;

FIG. 19 is a table illustrating results of Example 10;

FIG. 20 is a table illustrating results of Comparative Example 3;

FIG. 21 is a table illustrating results of Example 11;

FIG. 22 is a table illustrating results of Comparative Example 4;

FIG. 23 is a table illustrating results of Example 12;

FIG. 24 is a table illustrating results of Example 13;

FIGS. 25A and 25B are a table illustrating results of Example 14;

FIG. 26 is a table illustrating results of Comparative Example 5;

FIG. 27 is a table illustrating results of Comparative Example 6;

FIG. 28 is a table summarizing the results of Examples and Comparative Examples; and

FIG. 29 is a table illustrating output results in a case where state determination is performed at regular time intervals.

### DETAILED DESCRIPTION

Hereinafter, one or more embodiments of the present invention will be described with reference to the drawings. However, the scope of the invention is not limited to the disclosed embodiments.

Hereinafter, an embodiment of the present invention will be described with reference to the drawings.

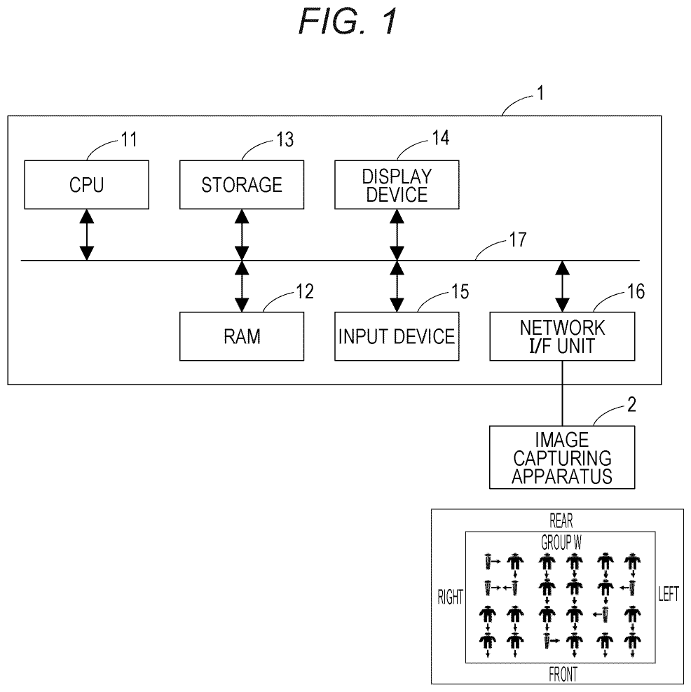

FIG. 1 is a diagram illustrating a configuration of a behavior state determination system according to an embodiment of the present invention. The behavior state determination system includes an information processing apparatus 1 and an image capturing apparatus 2.

The information processing apparatus 1 is a personal computer. The information processing apparatus 1 includes a CPU 11, a RAM 12, a storage 13, a display device 14, an input device 15, and a network interface unit (network I/F unit) 16. The CPU 11, the RAM 12, the storage 13, the display device 14, the input device 15, and the network I/F unit 16 are connected to each other via a system bus 17.

The CPU 11 comprehensively controls the entire behavior state determination system by executing an operation program stored in the storage 13 or the like and developed in the RAM 12. In particular, in this embodiment, the CPU 11 acquires image data transmitted from the image capturing apparatus 2 and determines a behavior state of a predetermined group. Processing of determining the behavior state will be described later.

The RAM 12 is a storage medium that provides a work area when the CPU 11 operates in accordance with the operation program.

The storage 13 includes a storage medium such as a hard disk. The storage 13 stores the operation program for the CPU 11, various types of management data, an application program, and the like. In this embodiment, information regarding the behavior state of the group determined by the information processing apparatus 1 is stored in time series.

The display device 14 includes a CRT, a liquid crystal display device, or the like. The display device 14 displays various messages, an input reception screen for a user, a selection screen, and the like.

The input device 15 is used for an input operation by the user, and includes a keyboard, a mouse, and the like.

The network interface unit 16 functions as a communication unit that transmits and receives data to and from the image capturing apparatus 2 and other external apparatuses via a network.

The image capturing apparatus 2 is an image capturing camera. The image capturing apparatus 2 continuously captures images of participants or a lecturer in time series with respect to a group W of the participants present in an indoor space or an outdoor space in a lecture, a class, a lecture meeting, or the like.

Image data (video) captured by the image capturing apparatus 2 is transmitted to the information processing apparatus 1. The information processing apparatus 1 receives the image data transmitted from the image capturing apparatus 2. The CPU 11 of the information processing apparatus 1 analyzes the image data and specifies the number and positions of the participants by using two-dimensional coordinates. The CPU 11 further extracts at least one of the orientation of the body, the orientation of the face, and the direction of the line of sight of each participant as state information, and performs analysis, evaluation, and the like which will be described later. A plurality of image capturing apparatuses 2 may be provided, instead of one image capturing apparatus 2.

In this embodiment, it is assumed that each participant faces the lecturer on a platform. Furthermore, the lecturer side is the front, the back side of each participant is the rear, the right side (left side in the figure) as viewed from the participant is the right, and the left side (right side in the figure) as viewed from the participant is the left. Therefore, when the participant faces the lecturer, the participant faces forward. In addition, there is a scene in which right and left participants face each other and make a discussion or the like during participation. In this case, the left and right participants often face each other in the right-left direction. Furthermore, when one of the participants speaks, the other participant often faces the speaker.

In this embodiment, in a case where the ratio of the number of participants facing each other in the right-left direction in the group W to the number of all the people in the group W is high, the behavior state of the group W is referred to as a “consultation state”. On the other hand, in a case where the ratio of the number of participants facing toward one speaker in the group W to the number of all the people in the group W is high, the behavior state of the group W is referred to as a “speaking state”.

It is extremely important to accurately grasp whether or not the behavior state of the group W is the “consultation state” in order to evaluate the behaviors of the lecturer and the participants.

Note that position information of the participants and the number of participants may be acquired not by using the two-dimensional coordinates of the image data of the image capturing apparatus 2 but by another method. For example, the position information of the participants and the number of participants may be acquired as two-dimensional coordinates by a position information acquiring apparatus such as a global positioning system (GPS). In addition, each participant may wear a device capable of detecting the orientation of the body, the orientation of the face, and the direction of the line of sight of each participant, and the orientation of the body, the orientation of the face, and the direction of the line of sight of each participant may be detected based on data transmitted from the device. Furthermore, the speaker may be identified by extracting, from the image data, characteristics of the speaker, such as whether the speaker holds a microphone or stands up. Alternatively, the speaker may be identified by causing each participant to hold a microphone.

In this embodiment, when the right and left participants face each other, it is assumed that the orientation of the body, the orientation of the face, and the direction of the line of sight of the participant are all toward the other participant. For this reason, whether or not the left and right participants face each other is determined based on whether or not the orientation of the body of the participant faces the other participant. However, there are also cases where only the face or the line of sight of the participant is facing the other participant and the body of the participant is not facing the other participant. Furthermore, only the line of sight of the participant may be directed toward the other participant. Therefore, it may be determined whether or not the participant is facing the other participant by determining the orientation of the face or direction of the line of sight without determining the orientation of the body. It is preferable to determine whether or not the participants face each other based on at least one of the orientation of the body, the orientation of the face, and the direction of the line of sight of each of the participants.

Next, behavior state determination processing for determining whether or not the behavior state of the group W is the “consultation state” will be described.

The behavior state determination processing is executed by the CPU 11 of the information processing apparatus 1 operating in accordance with a behavior state determination program that is an operation program. The behavior state determination program may be stored in advance in a recording medium such as the storage 13. Alternatively, the behavior state determination program stored in a portable recording medium such as a CD-ROM may be installed in the information processing apparatus. Alternatively, the behavior state determination program may be downloaded from a server or the like via a network and installed.

The behavior state determination processing is performed in the order of division processing, extraction processing, and determination processing.
(1) Division Processing

A group of participants in an indoor space or an outdoor space is divided into a plurality of groups including at least a first group and a second group so as to satisfy the following relational formula [1].

$$0.23 \leq x / w \leq {0.77}^{** *} \qquad [ 1 ]$$

Here, x is the number of people in the first group, and w is the total number of people in the space, that is, the total number of participants.

A boundary line between the first group and the second group at the time of division may be a straight line or a curved line. An inflection point may be provided in the middle of the boundary line in consideration of the shape of the group and the arrangement of people, desks, chairs, and the like.

Note that the first group X when the group W is divided into the plurality of groups is not limited. Any group out of the plurality of divided groups is set as the first group X. Therefore, in a case of dividing into two groups, for example, the states of the groups after the group is divided such that x/w is 0.25 are the same as the states of the groups after the group is divided such that x/w is 0.75.

By dividing into a plurality of groups so as to satisfy the relational formula [1], the accuracy of determination is improved. This point will be described later.

In addition, in order to further improve the accuracy of determination, a boundary group may be selected in a boundary region between adjacent groups at the time of the division so as to satisfy the following relational formula [2].

$$0.33 \leq m / w \leq {0.75}^{** *} \qquad [ 2 ]$$

Note that m is the number of people in the boundary group, and w is the total number of people in the space.
(2) Extraction Processing

Next, the information processing apparatus 1 extracts state information regarding each person in each of the divided groups. The state information is the orientation of each participant in this example.

When selecting the boundary group M, the information processing apparatus 1 extracts the state information regarding each person in the boundary group M in addition to the divided groups.
(3) Determination Processing

Next, the information processing apparatus 1 compares the extracted state information regarding each participant with evaluation criterion information set in advance to determine the behavior state of the group, in other words, whether the state is a “consultation state” or not.

When selecting the boundary group, the information processing apparatus 1 determines the behavior state of the group in consideration of the state information regarding each participant in the boundary group.

In order to verify the processing (1) to (3) described above, the information processing apparatus 1 performed several specific determination processes described below by using a group W of a plurality of virtual participants.

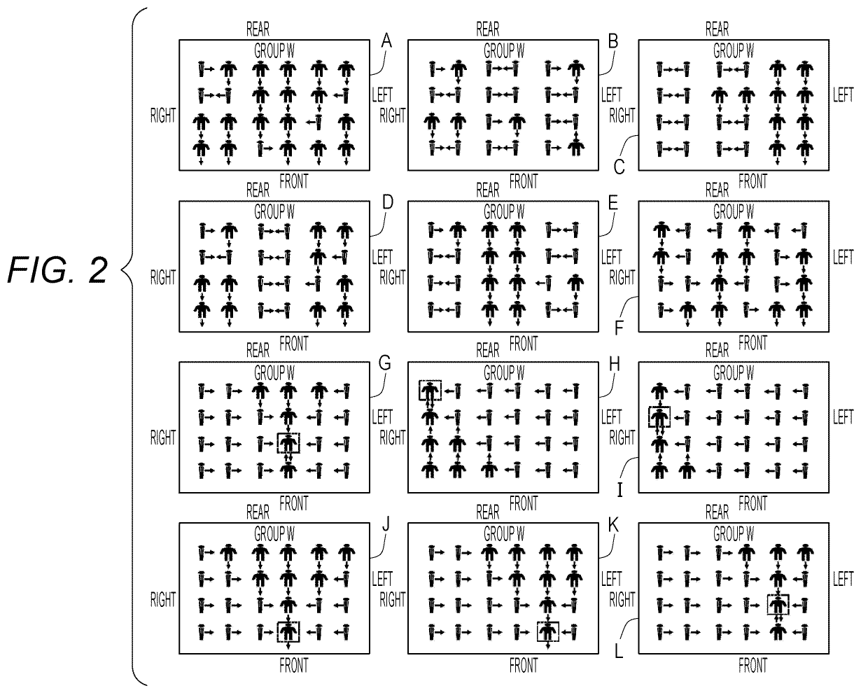

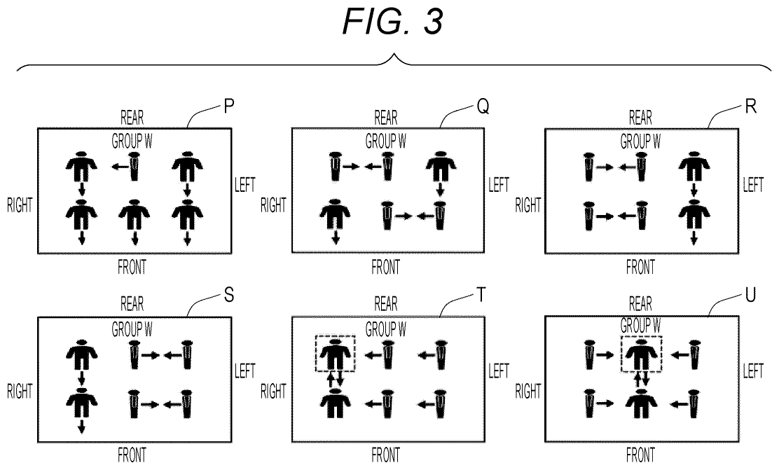

FIG. 2 illustrates examples A to L of the virtual participant group W, and FIG. 3 illustrates examples P to U of the virtual participant group W.

In each group W, one black mark represents one participant, and the participants are arranged vertically and horizontally. In each example illustrated in FIG. 2, the number w of participants in the group W is 24. In each example illustrated in FIG. 3, the number w of participants in the group W is 6.

In addition, in each group W illustrated in FIGS. 2 and 3, a participant facing forward or backward and a participant facing left or right are distinguished by two types of black marks. An arrow illustrated in association with each participant indicates the orientation of the participant. Therefore, in the example A illustrated in FIG. 2, the number of participants facing right is 3, the number of participants facing left is 3, the number of participants facing forward is 18, and the number of participants facing backward is 0. Also in each of the other examples B to L illustrated in FIG. 2 and the examples M to S illustrated in FIG. 3, the number and positions of the participants facing in each direction are appropriately set.

In each of the examples G to L illustrated in FIG. 2 and the examples T and U illustrated in FIG. 3, a participant surrounded by a rectangular frame is a speaker. That is, in each of the examples G to L illustrated in FIG. 2 and the examples T and U illustrated in FIG. 3, the behavior state of the group W is classified into the “speaking state”. In each of the examples B, C, D, and E illustrated in FIG. 2 and the examples Q, R, and S illustrated in FIG. 3, the ratio of the number of participants facing each other in the right-left direction to the number of all the people in the group W is high. Therefore, the behavior state of the group W is classified into the “consultation state”. In each of the examples A and F illustrated in FIG. 2 and the example P illustrated in FIG. 3, the ratio of the number of participants facing each other in the right-left direction to the number of all the people in the group W is low, and no speaker is present. Therefore, the behavior state of the group W is classified as “others”. Note that in this embodiment, the group W in the “speaking state” is also classified as the “others”.

Next, a state in which the group W of all the participants is divided into a plurality of groups will be described.

### Example 1

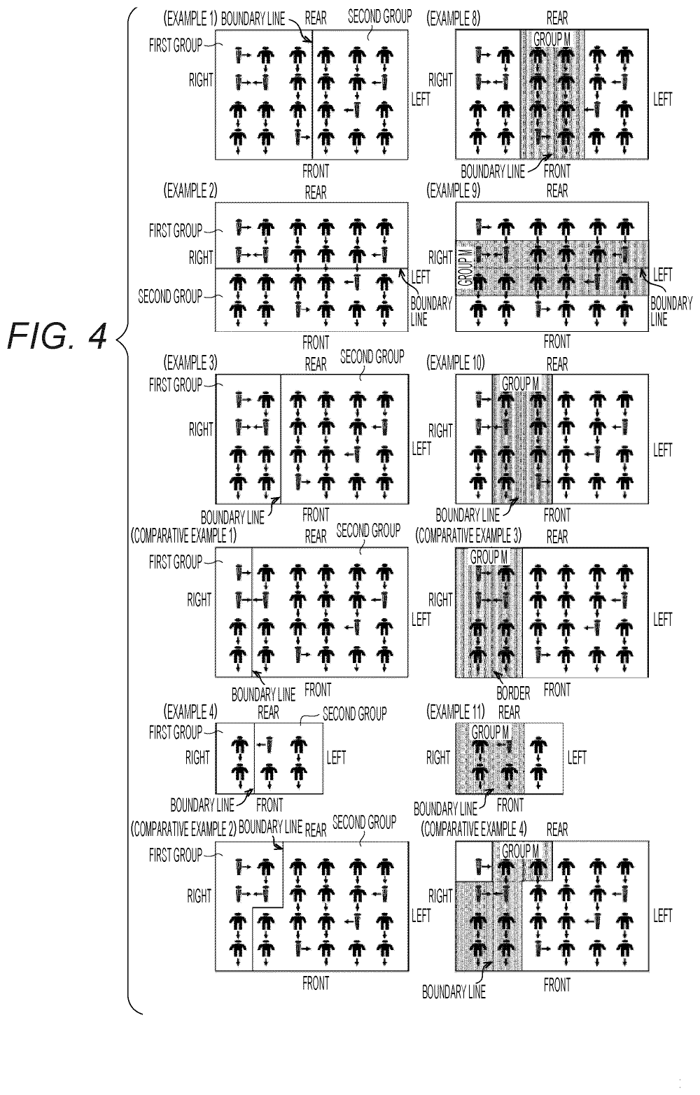

In Example 1, as illustrated in FIG. 4 (Example 1), a boundary line is set in the front-rear direction at the center in the right-left direction, and the group W is equally divided into right and left groups. The group is divided into a first group X positioned on the right side (left side in the drawing) and a second group Y positioned on the left side (right side in the drawing). The number of participants belonging to each of the first group X and the second group is 12, and the ratio of the number of people in the first group X to the number of people in the group W is 0.5.

In the example illustrated in FIG. 4, the group W illustrated in the example A in FIG. 2 is exemplified, but each of the groups W illustrated in the examples B to L in FIG. 2 is also divided in a similar manner.

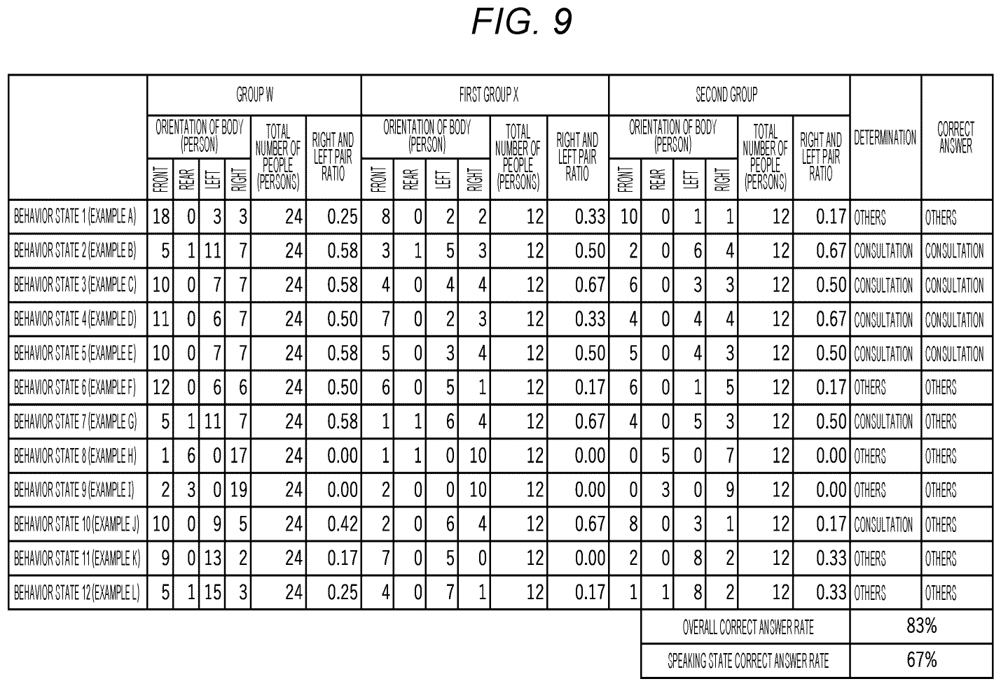

Then, regarding each of the groups W illustrated in the examples A to L in FIG. 2, the number of participants belonging to each group, the number of participants facing in each of the front, rear, left, and right directions, and a right and left pair ratio were examined for the group W and the divided first group X and the divided second group. FIG. 8 is a table illustrating the results.

A “behavior state 1 (example A)” in the leftmost item of the table of FIG. 8 indicates values obtained by examining the group W, the first group, and the second group illustrated in the example A in FIG. 2. The same applies to “behavior state 2 (example B)” and other behavior states.

The right and left pair ratio is the ratio of the number of participants facing each other to the left and to the right to the number of all the people in the group W, and was calculated by the following formula [2].

$$The right and left pair ratio = MIN ( number of people facing left , number of people facing right ) \times 2 / the total number of the people facing in all {directions}^{** *} \qquad [ 2 ]$$

In Formula [2], “MIN (number of people facing left, number of people facing right)” indicates the smaller one of the number of people facing left and the number of people facing right in the group. The “total number of the people facing in all directions” is equal to the number of all the participants in the group.

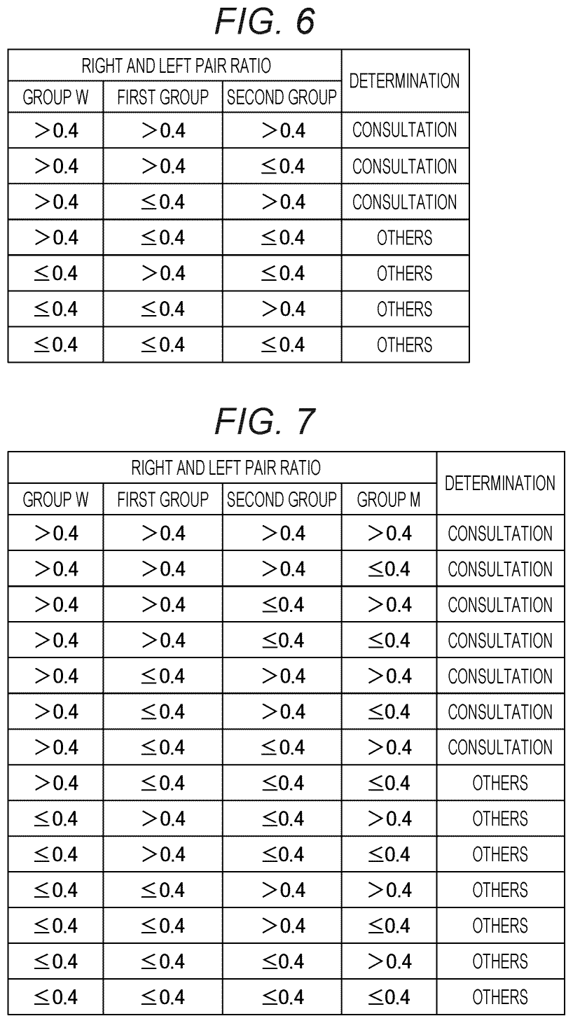

Next, from the right and left pair ratios obtained for the group W, the first group X, and the second group, it was determined whether the behavior state of the group W was the “consultation state” or the “others” (including the “speaking state”) other than the “consultation state”. The determination was made in accordance with an evaluation criterion 1 in a table of FIG. 6.

The evaluation criterion 1 illustrated in FIG. 6 is used to determine, for each of the group W, the first group X, and the second group, whether the state is the “consultation state” (simply described as “consultation” in the table) or the “others” according to a combination of results of determination as to whether the right and left pair ratio is equal to or smaller than 0.4 or larger than 0.4.

The determination results for the respective groups W are also illustrated in the table in FIG. 8. The item of “determination” in the table of FIG. 8 indicates determination results determined based on the evaluation criterion 1 illustrated in FIG. 6 from the right and left pair ratios. The item of “correct answer” indicates an actual behavior state for each group W illustrated in the examples A to L in FIG. 2. As described above, each of the groups W illustrated in the examples B, C, D, and E in FIG. 2 is classified into the “consultation state”, and each of the groups W illustrated in the examples A and F to L in FIG. 2 is classified into the “others”.

An overall correct answer rate and a speaking state correct answer rate are obtained from comparison between the item of “determination” and the item of “correct answer” in the table of FIG. 8 and are listed in the same table. The overall correct answer rate indicates a rate of correct determination for each group W in the behavior state 1 (example A) to a behavior state 12 (example L in FIG. 2). In Example 1, the determination results for the behavior state 4 (example D in FIG. 2) and the behavior state 6 (example F in FIG. 2) are different from the actual behavior states. Therefore, the overall correct answer rate was 10÷12≈83%.

In addition, the speaking state correct answer rate indicates a rate of correct determination for each of a total of six groups W in the “speaking state” illustrated in the examples G to L in FIG. 2. In this Example 1, all the groups were determined as the “others” and matched the actual states, no erroneous determination was made, and the speaking state correct answer rate was 100%.

### Example 2

In Example 2, as illustrated in FIG. 4 (Example 2), a boundary line is set in the right-left direction such that the ratio of the number of people in a first group X to the number of people in the group W is 0.5, and the group W is divided into the first group X and a second group in the front-rear direction.

In FIG. 4 (Example 2), the group W illustrated in the example A in FIG. 2 is exemplified, but each of the groups W illustrated in the examples B to L in FIG. 2 is also divided in a similar manner.

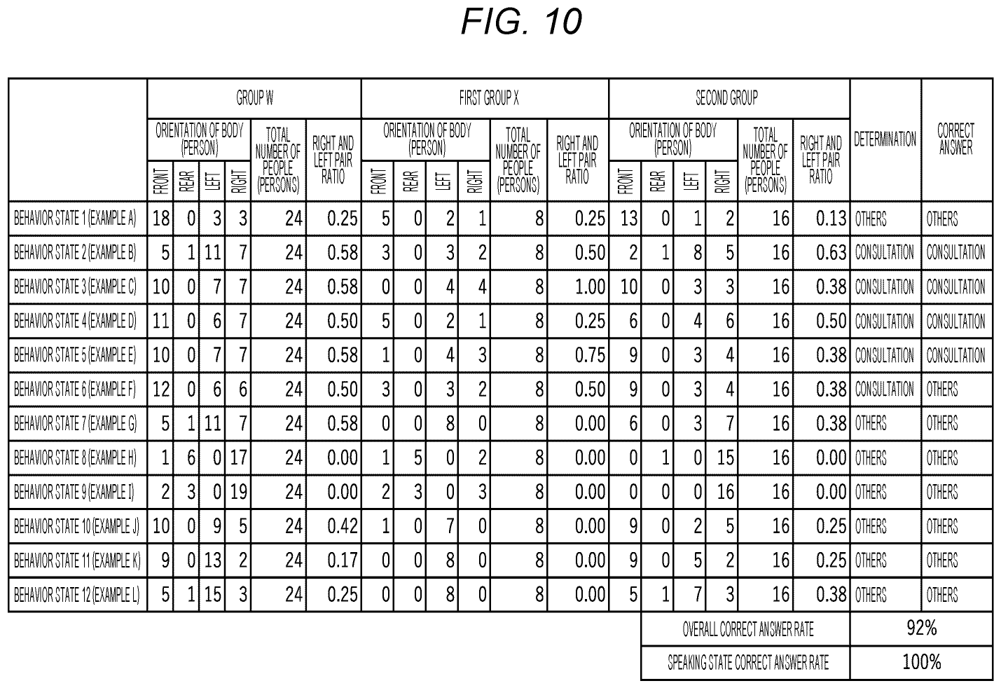

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 9 is a table illustrating the results.

Next, as in Example 1, it was determined whether the behavior state of the group W was the “consultation state” or the “others” (including the “speaking state”) other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 9.

As is understood from comparison between the item of “determination” and the item of “correct answer” in the table of FIG. 9, the determination results for the behavior state 7 (example G in FIG. 2) and the behavior state 10 (example J in FIG. 2) are different from the actual behavior states. Therefore, the overall correct answer rate was 83%. In addition, for the group W in the “speaking state” in each of the examples G to L illustrated in FIG. 2, two erroneous determinations were made, and thus the speaking state correct answer rate was 67%.

### Example 3

In this Example 3, as illustrated in FIG. 4 (Example 3), a boundary line is set in the front-rear direction such that the ratio of the number of people in a first group to the number of people in the group W is 0.33, and the group W is divided into the first group and a second group in the right-left direction. Note that the first group and the second group may be switched, and the ratio of the number of people in the first group X to the number of people in the group W may be 0.67.

In the example illustrated in FIG. 4 (Example 3), the group W illustrated in the example A in FIG. 2 is exemplified, but each of the groups W illustrated in the examples B to L in FIG. 2 is also divided in a similar manner.

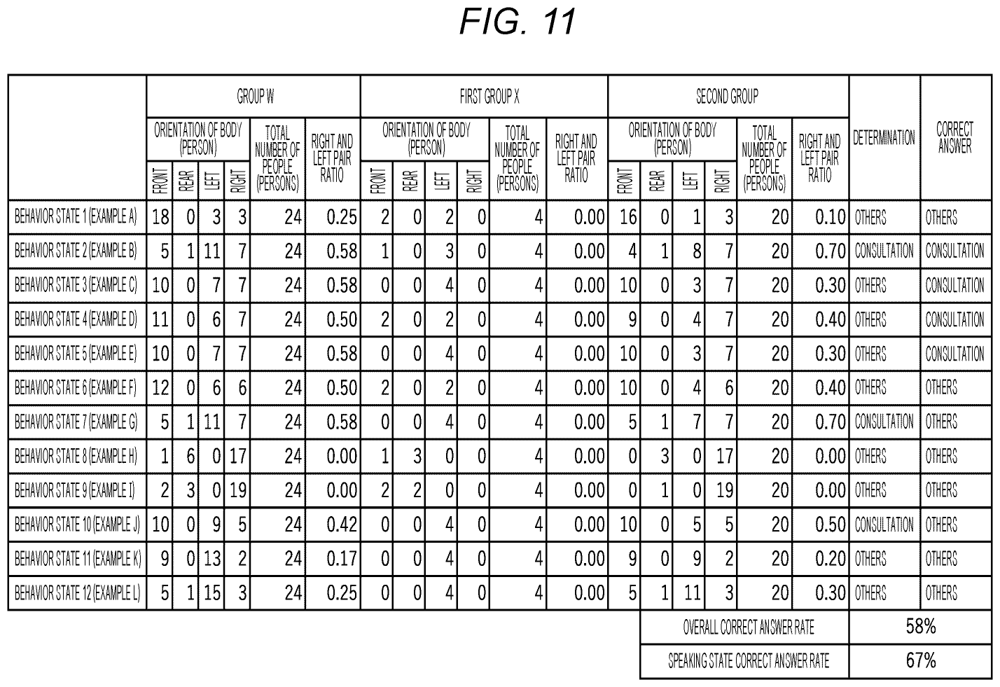

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 10 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 10.

As is understood from comparison between the item of “determination” and the item of “correct answer” in the table of FIG. 10, the determination result for the behavior state 6 (example F) is different from the actual behavior state. Therefore, the overall correct answer rate was 92%. Furthermore, since all of the groups W in the “speaking state” illustrated in the examples G to L in FIG. 2 had determination results of the “others” and no erroneous determination was made, the speaking state correct answer rate was 100%.

### Comparative Example 1

In this Comparative Example 1, as illustrated in FIG. 4 (Comparative Example 1), a boundary line is set in the front-rear direction such that the ratio of the number of people in a first group to the number of people in the group W is 0.17, and the group W is divided into the first group and a second group in the right-left direction.

In the example illustrated in FIG. 4 (Comparative Example 1), the group W illustrated in the example A in FIG. 2 is exemplified, but each of the groups W illustrated in the examples B to L in FIG. 2 is also divided in a similar manner.

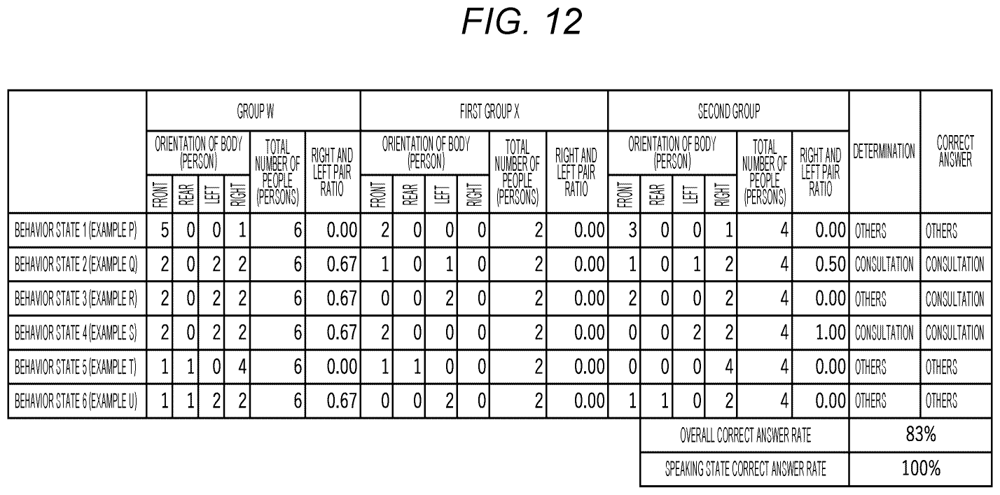

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 11 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 11.

As is understood from comparison between the item of “determination” and the item of “correct answer” in the table of FIG. 11, the determination results for the behavior state 3 (example C), the behavior state 4 (example D), the behavior state 5 (example E), the behavior state 7 (example G), and the behavior state 10 (example J) are different from the actual behavior states. Therefore, the overall correct answer rate was 58%. In addition, for the group W in the “speaking state” in each of the examples G to L illustrated in FIG. 2, two erroneous determinations were made, and thus the speaking state correct answer rate was 67%.

### Example 4

Example 4 is an example in which the state determination is performed on a group W including 6 participants as illustrated in FIG. 3.

As illustrated in FIG. 4 (Example 4), a boundary line is set in the front-rear direction such that the ratio of the number of people in a first group to the number of people in a group W of 6 people is 0.33, and the group W is divided into the first group and a second group in the right-left direction.

In the example illustrated in FIG. 4 (Example 4), the group W illustrated in the example P in FIG. 3 is exemplified, but each of the groups W illustrated in the examples Q to U in FIG. 3 is also divided in a similar manner.

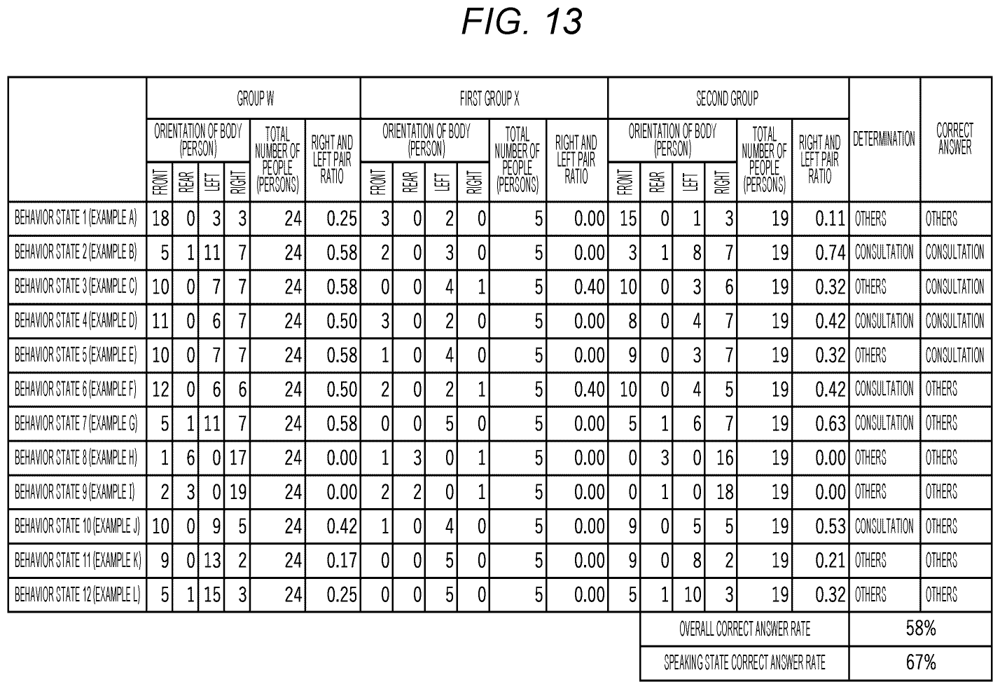

Then, as in Example 1, regarding each of the groups W illustrated in the examples P to U in FIG. 3, the number of participants belonging to each group, the number of participants facing in each of the front, rear, left, and right directions, and the right and left pair ratio were examined for each of the group W, the divided first group X, and the divided second group. FIG. 12 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 12.

As is understood from comparison between the item of “determination” and the item of “correct answer” in the table of FIG. 12, the determination result for the behavior state 3 (example R) is different from the actual behavior state. Therefore, the overall correct answer rate was 83%. In addition, since all of the two groups W of the “speaking state” illustrated in the examples T and U in FIG. 3 had determination results of the “others”, and no erroneous determination was made, the speaking state correct answer rate was 100%.

### Comparative Example 2

In Comparative Example 2, as illustrated in FIG. 4 (Comparative Example 2), a boundary line having an inflection point in the front-rear direction is set such that the ratio of the number of people in a first group to the number of people in the group W is 0.21, and the group W is divided into the first group X and a second group in the right-left direction.

In the example illustrated in FIG. 4 (Comparative Example 2), the group W illustrated in example A illustrated in FIG. 2 is exemplified, but each of the groups W in examples B to L illustrated in FIG. 2 is also divided in a similar manner.

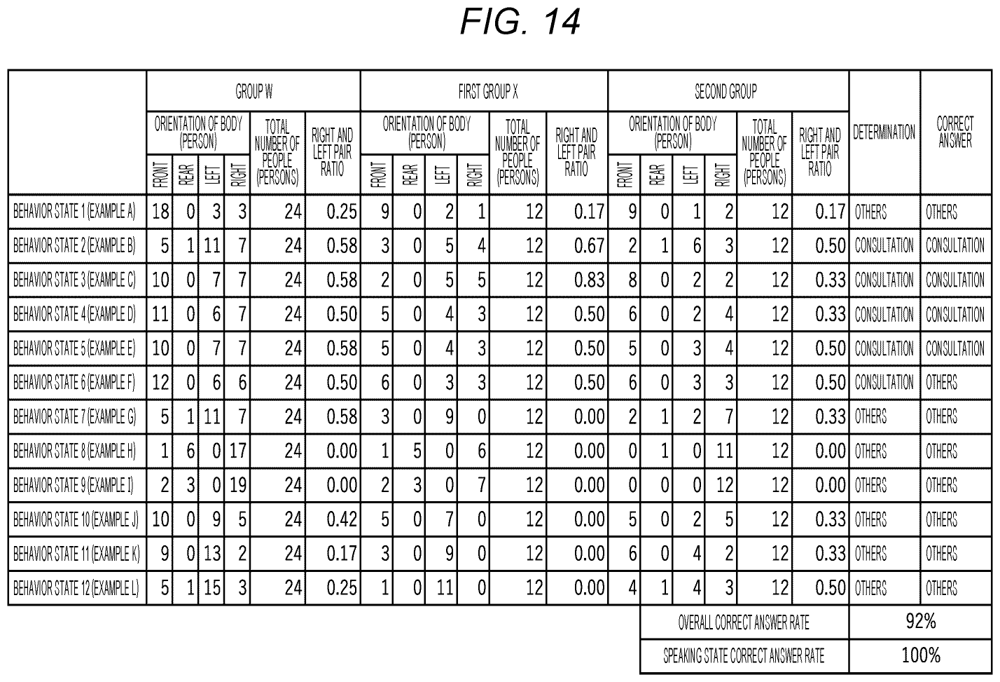

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 13 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 13.

As is understood from comparison between the item of “determination” and the item of “correct answer” in the table of FIG. 13, the determination results for the behavior state 3 (example C), the behavior state 5 (example E), the behavior state 6 (example F), the behavior state 7 (example G), and the behavior state 10 (example J) are different from the actual behavior states. Therefore, the overall correct answer rate was 58%. In addition, for the group W in the “speaking state” in each of the examples G to L illustrated in FIG. 2, two erroneous determinations were made, and thus the speaking state correct answer rate was 67%.

### Example 5

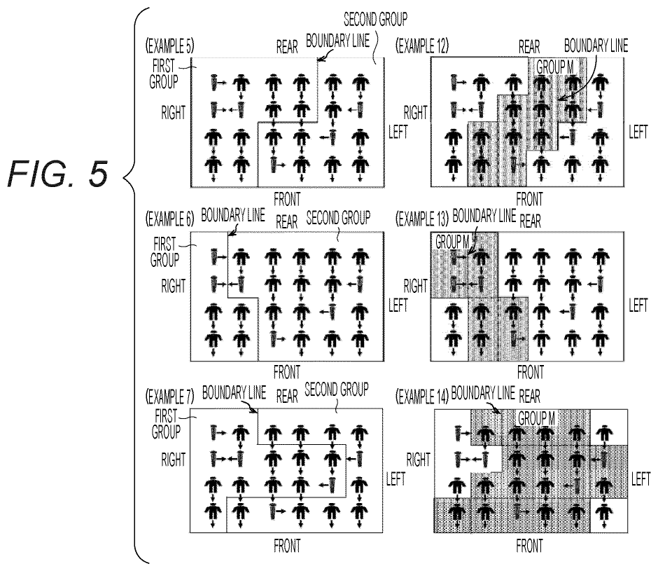

In this Example 5, as illustrated in FIG. 5 (Example 5), a boundary line having an inflection point in the front-rear direction is set such that the ratio of the number of people in a first group to the number of people in the group W is 0.5, and the group W is divided into the first group and a second group in the right-left direction.

Although the group W illustrated in the example A in FIG. 2 is exemplified in the example in FIG. 5 (Example 5), each of the groups W illustrated in the examples B to L in FIG. 2 is also divided in a similar manner.

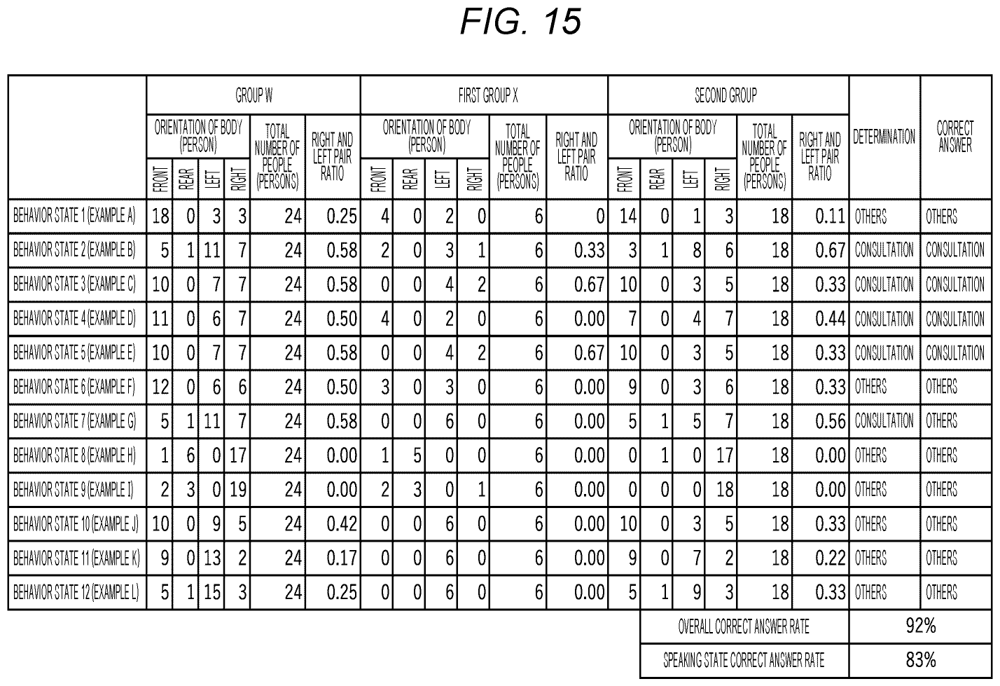

Next, as in Example 1, for each of the group W, the divided first group X, and the divided second group, the number of participants belonging to each of the groups, the number of participants facing in each of the front, rear, left, and right directions, and the right and left pair ratio were examined. FIG. 14 is a table illustrating the results.

Next, as in Example 1, for each of the groups W illustrated in the examples A to L in FIG. 2, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 14.

As is understood from comparison between the item of “determination” and the item of “correct answer” in the table of FIG. 14, the determination result for the behavior state 6 (example F) is different from the actual behavior state. Therefore, the overall correct answer rate was 92%. In addition, since all of the groups W in the “speaking state” illustrated in the examples G to L in FIG. 2 had determination results of the “others” and no erroneous determination was made, the speaking state correct answer rate was 100%.

### Example 6

In this Example 6, as illustrated in FIG. 5 (Example 6), a boundary line having an inflection point in the front-rear direction is set such that the ratio of the number of people in a first group to the number of people in the group W is 0.25, and the group W is divided into the first group and a second group in the right-left direction.

In the example of FIG. 5 (Example 6), the group W illustrated in the example A in FIG. 2 is exemplified, but each of the groups W illustrated in the examples B to L in FIG. 2 is also divided in a similar manner.

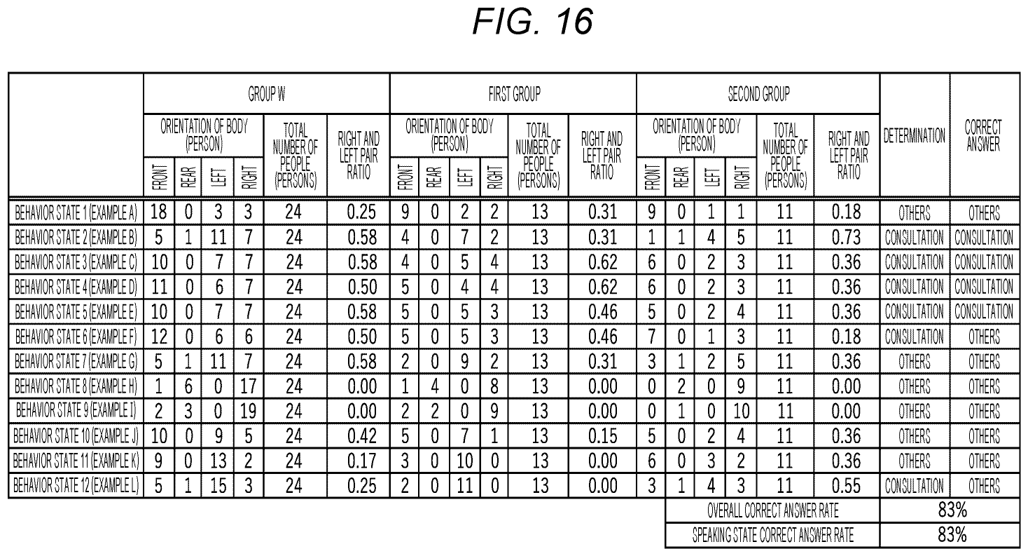

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 15 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 15.

As is understood from comparison between the item of “determination” and the item of “correct answer” in the table of FIG. 15, the determination result for the behavior state 7 (example G) is different from the actual behavior state. Therefore, the overall correct answer rate was 92%. In addition, since one erroneous determination was made for the group W in the “speaking state” in each of the examples G to L illustrated in FIG. 2, the correct answer rate was 83%.

### Example 7

In this Example 7, as illustrated in FIG. 5 (Example 7), a boundary line having an inflection point in the front-rear direction is set such that the ratio of the number of people in a first group to the number of people in the group W is 0.54, and the group W is divided into the first group and a second group in the right-left direction.

In the example of FIG. 5 (Example 7), the group W illustrated in the example A in FIG. 2 is exemplified, but each of the groups W illustrated in the examples B to L in FIG. 2 is also divided in a similar manner.

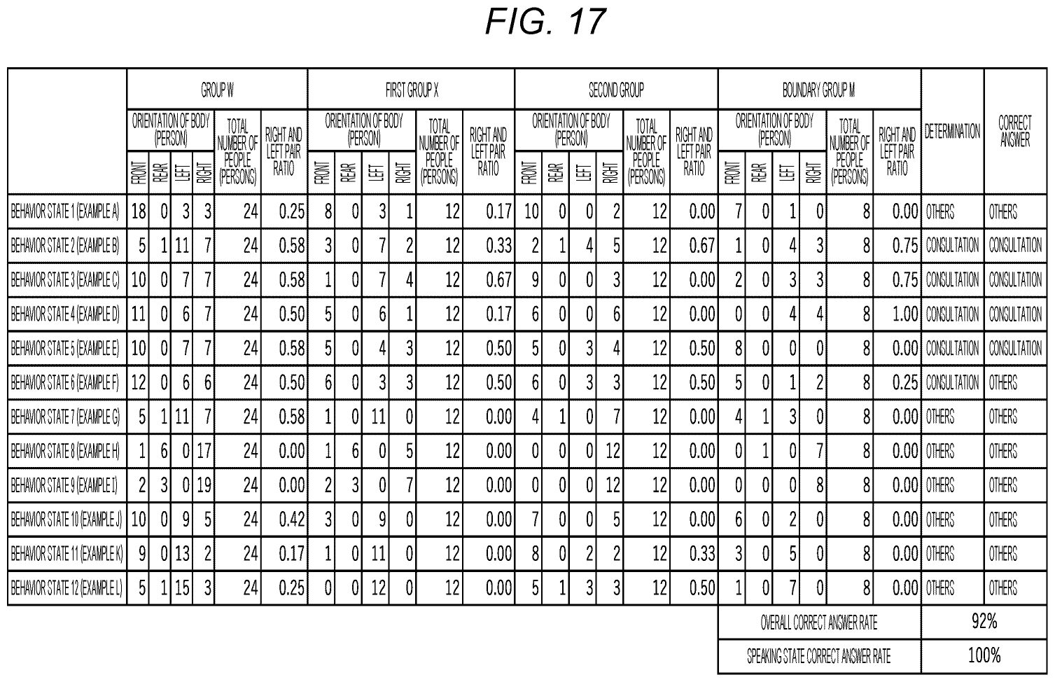

Next, as in Example 1, regarding each of the groups W illustrated in the examples A to L in FIG. 2, the number of participants belonging to each of the groups, the number of participants facing in each of the front, rear, left, and right directions, and the right and left pair ratio were examined for each of the group W, the divided first group X, and the second group. FIG. 16 is a table illustrating the results.

Next, as in Example 1, it was determined whether the behavior state of the group W was the “consultation state” or the “others” other than the “consultation state” from the right and left pair ratios obtained for the group W, the first group X, and the second group. The determination was performed in accordance with the evaluation criterion 1 illustrated in FIG. 6. The determination results are also illustrated in the table of FIG. 16.

As is understood from comparison between the item of “determination” and the item of “correct answer” in the table of FIG. 16, the determination results for the behavior state 6 (example F) and the behavior state 12 (example L) are different from the actual behavior states. Therefore, the overall correct answer rate was 83%. In addition, since one erroneous determination was made for the group W in the “speaking state” in each of the examples G to L illustrated in FIG. 2, the correct answer rate was 83%.

### Example 8

In this Example 8, as illustrated in FIG. 4 (Example 8), a boundary line (the same boundary line as that in Example 1) is set in the front-rear direction such that the ratio of the number of people in a first group to the group W is 0.5, and the group W is divided into the first group and a second group in the right-left direction. Furthermore, people closest to the boundary line are extracted from the first group X and the second group, and a boundary group M along the set boundary line is selected. In Example 8, the boundary group M is illustrated in gray.

Although the group W illustrated in the example A in FIG. 2 is exemplified in the example in FIG. 4 (Example 8), each of the groups W illustrated in the examples B to L in FIG. 2 is also divided in a similar manner and a boundary group M is selected in each of the examples B to L in FIG. 2.

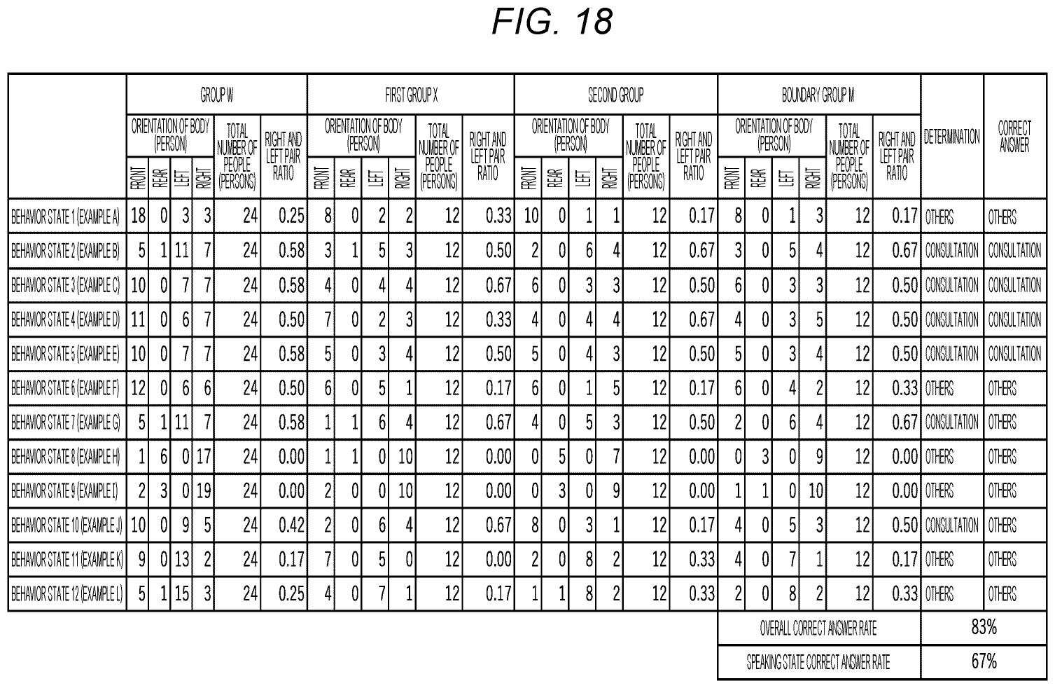

Then, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 17 is a table illustrating the results.

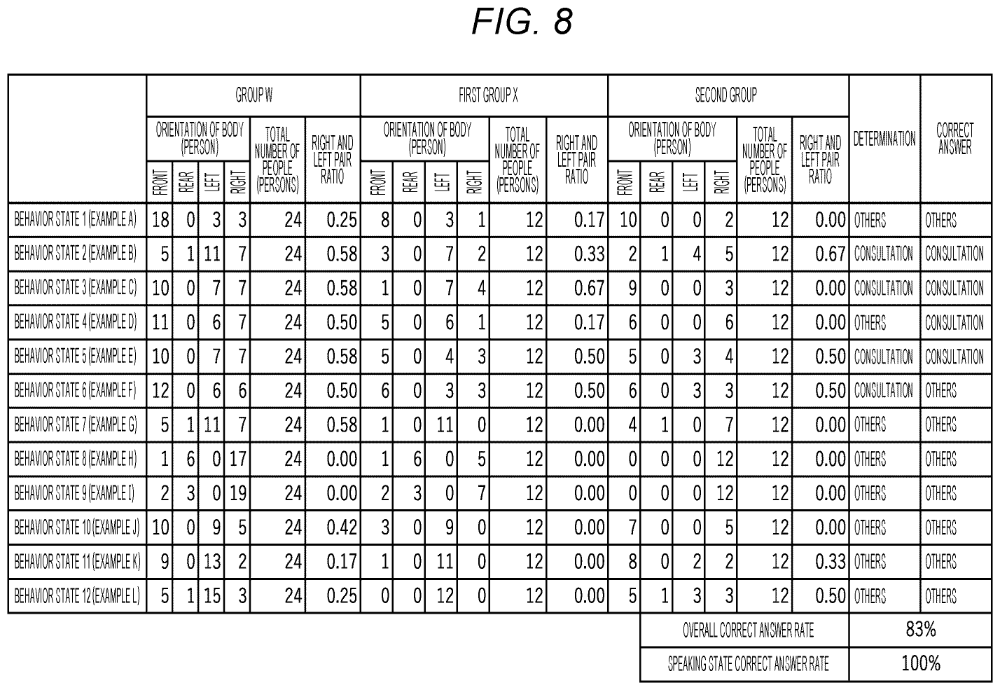

Next, from the right and left pair ratios obtained for the group W, the first group X, the second group, and the boundary group M, it was determined whether the behavior state of the group W was the “consultation state” or the “others” other than the “consultation state”. The determination was made in accordance with an evaluation criterion 2 illustrated in FIG. 7.

The evaluation criterion 2 illustrated in FIG. 7 is used to determine whether a behavior state of each of the group W, the first group X, the second group, and the boundary group M is the “consultation state” or the “others” according to a combination of results of determining whether the right and left pair ratio is equal to or smaller than 0.4 or larger than 0.4.

The determination results are also illustrated in the table of FIG. 17.

As is understood from comparison between the item of “determination” and the item of “correct answer” in the table of FIG. 17, only the determination result for the behavior state 6 (example F) is different from the actual behavior state. Therefore, the overall correct answer rate was 92%. In addition, all the groups W in the “speaking state” illustrated in the examples G to L in FIG. 2 are determined as the “others”, and no erroneous determination was made, and thus the speaking state correct answer rate is 100%.

### Example 9

In this Example 9, as illustrated in FIG. 4 (Example 9), a boundary line (the same boundary line as that in Example 2) is set in the right-left direction such that the ratio of the number of people in a first group X to the group W is 0.5, and the group W is divided into the first group X and a second group in the front-rear direction. Furthermore, people closest to the boundary line are extracted from the first group X and the second group, and a boundary group M along the set boundary line is selected. In FIG. 4 (Example 9), the boundary group M is illustrated in gray.

Although the group W illustrated in the example A illustrated in FIG. 2 is exemplified in the example in FIG. 4 (Example 9), each of the groups W illustrated in the examples B to L in FIG. 2 is also divided in a similar manner and a boundary group M is selected in each of the examples B to L in FIG. 2.

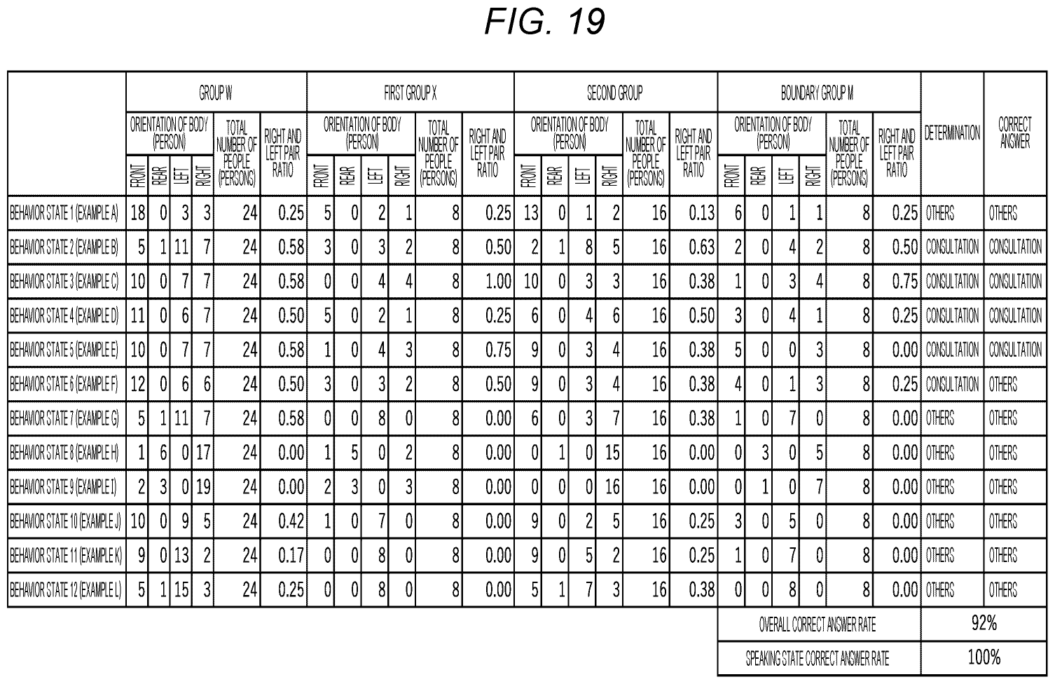

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 18 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 18.

As is understood from comparison between the item of “determination” and the item of “correct answer” in the table of FIG. 18, the determination results for the behavior state 7 (example G) and the behavior state 10 (example J) are different from the actual behavior states. Therefore, the overall correct answer rate was 83%. In addition, for the group W in the “speaking state” in each of the examples G to L illustrated in FIG. 2, two erroneous determinations were made, and thus the speaking state correct answer rate was 67%.

### Example 10

In this Example 10, as illustrated in FIG. 4 (Example 10), a boundary line (the same boundary line as that in Example 2) is set in the front-rear direction such that the ratio of the number of people in a first group to the group W is 0.33, and the group W is divided into the first group and a second group in the right-left direction. Furthermore, people closest to the boundary line are extracted from the first group X and the second group, and a boundary group M along the set boundary line is selected. In FIG. 4 (Example 10), the boundary group M is illustrated in gray.

In the example illustrated in FIG. 4 (Example 10), the group W illustrated in the example A in FIG. 2 is exemplified, but each of the groups W illustrated in the examples B to L in FIG. 2 is also divided in a similar manner and a boundary group M is selected in each of the examples B to L in FIG. 2.

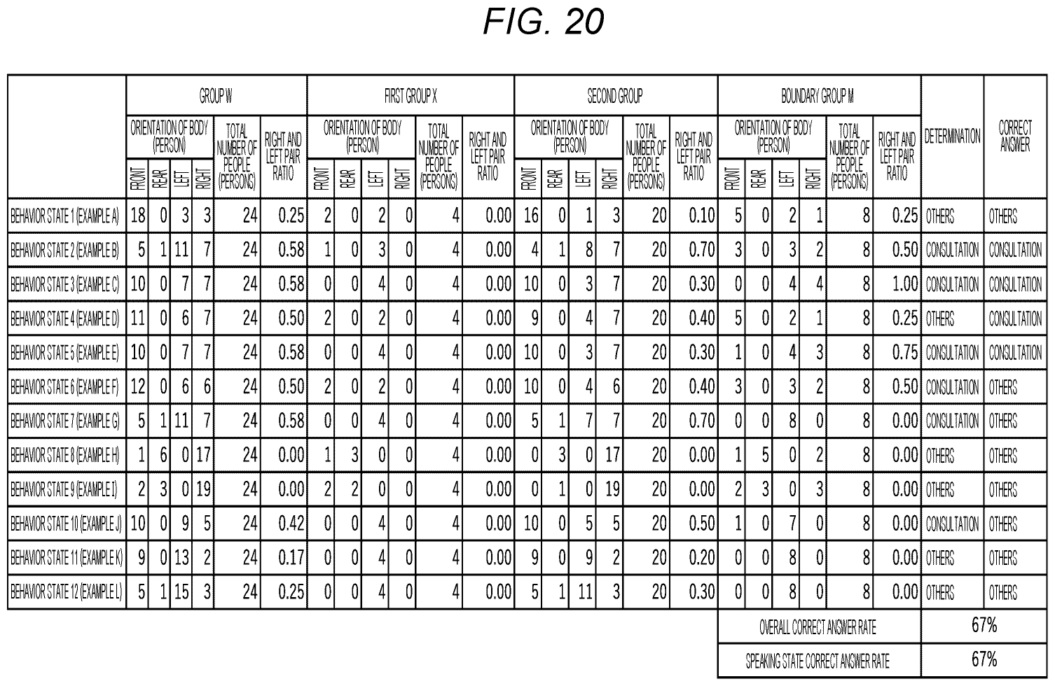

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 19 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 19.

As is understood from comparison between the item of “determination” and the item of “correct answer” in the table of FIG. 19, only the determination result for the behavior state 6 (example F) is different from the actual behavior state. Therefore, the overall correct answer rate was 92%. In addition, no erroneous determination was made for the group W in the “speaking state” illustrated in the examples G to L in FIG. 2, and the correct answer rate was 100%.

### Comparative Example 3

In Comparative Example 3, as illustrated in FIG. 4 (Comparative Example 3), a boundary line (the same boundary line as that in Comparative Example 1) is set in the front-rear direction such that the ratio of the number of people in a first group to the group W is 0.17, and the group W is divided into the first group and a second group in the right-left direction. Furthermore, people closest to the boundary line are extracted from the first group X and the second group, and a boundary group M along the set boundary line is selected. In FIG. 4 (Comparative Example 3), the boundary group M is illustrated in gray.

In the example illustrated in FIG. 4 (Comparative Example 3), the group W illustrated in the example A in FIG. 2 is exemplified, but each of the groups W illustrated in the examples B to L in FIG. 2 is also divided in a similar manner and a boundary group M is selected in each of the examples B to L in FIG. 2.

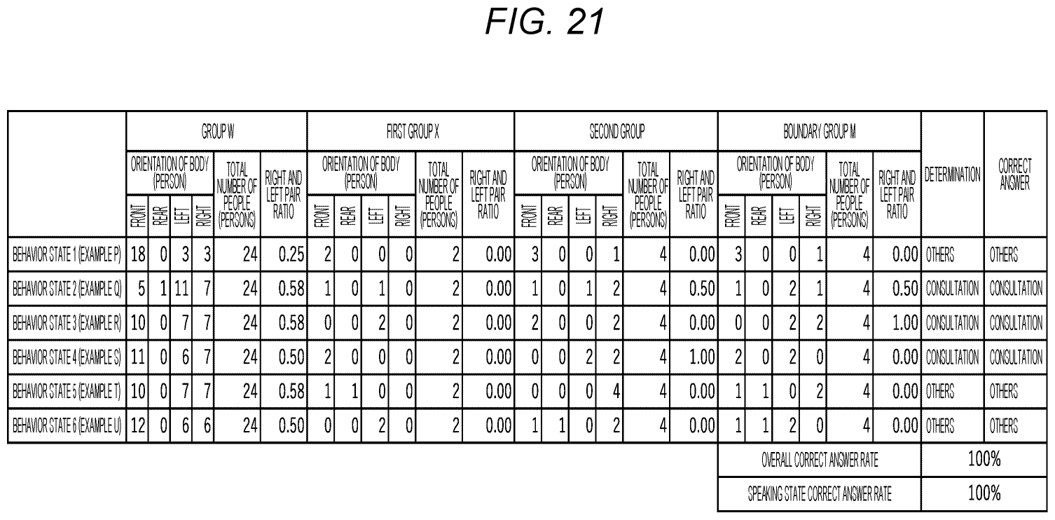

Then, as in Example 8, for the group W, the first group X, the second group, and the boundary group M, the number of participants belonging to each of the groups, the number of participants facing in each of the front, rear, left, and right directions, and the right and left pair ratio were examined. FIG. 20 is a table illustrating the results.

Next, as in Example 8, for each group W illustrated in the examples A to L in FIG. 2, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 20.

As is understood from comparison between the item of “determination” and the item of “correct answer” in the table illustrated in FIG. 20, the determination results for the behavior state 4 (example D), the behavior state 6 (example F), the behavior state 7 (example G), and the behavior state 10 (example J) are different from the actual behavior states. Therefore, the overall correct answer rate was 67%. Furthermore, since two incorrect determinations were made for the group W in the “speaking state” illustrated in the examples G to L in FIG. 2, the speaking state correct answer rate was 67%.

### Example 11

Example 11 is an example in which a boundary group M was selected for a group W including 6 participants, and the state determination was performed.

As illustrated in FIG. 4 (Example 11), a boundary line (the same boundary line as that in Example 4) is set in the front-rear direction such that the ratio of the number of people in a first group to the group W of 6 people is 0.33, and the group W is divided into the first group and a second group in the right-left direction. Furthermore, people closest to the boundary line are extracted from the first group X and the second group, and a boundary group M along the set boundary line is selected. In FIG. 4 (Example 11), the boundary group M is illustrated in gray.

In the example illustrated in FIG. 4 (Example 11), the group W illustrated in the example P in FIG. 3 is exemplified, but each of the groups W illustrated in the examples Q to U in FIG. 3 is also divided in a similar manner, and a boundary group M is selected in each of the examples Q to U in FIG. 3.

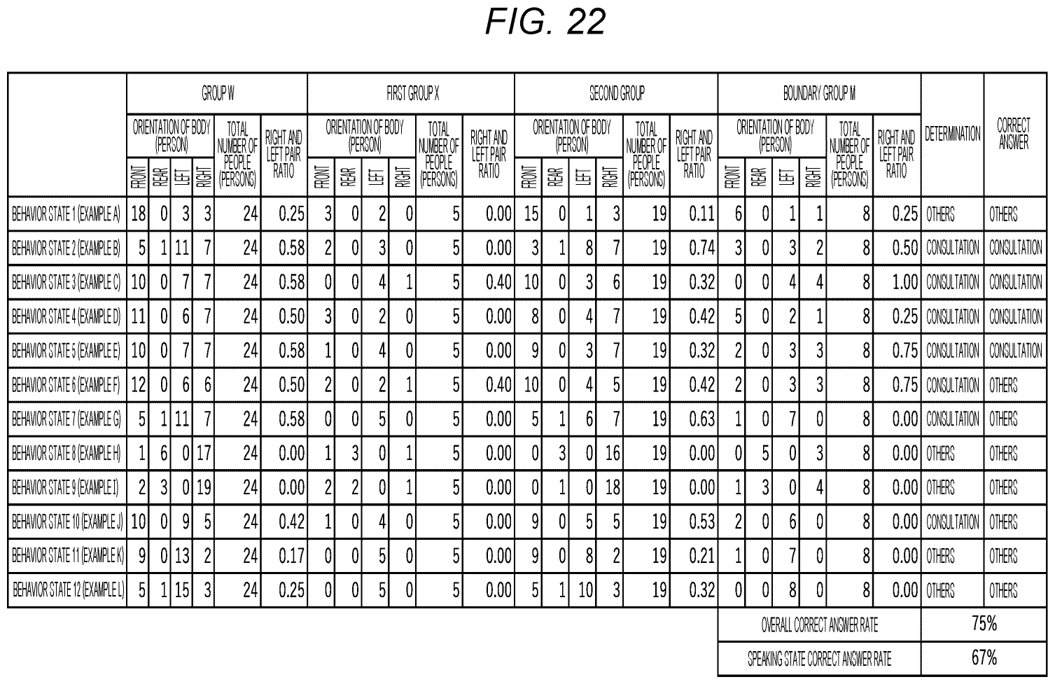

Then, as in Example 8, for the group W, the first group X, the second group, and the boundary group M, the number of participants belonging to each of the groups, the number of participants facing in each of the front, rear, left, and right directions, and the right and left pair ratio were examined. FIG. 21 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 21.

As is understood from comparison between the item of “determination” and the item of “correct answer” in the table illustrated in FIG. 21, no erroneous determination was made, and both of the overall correct answer rate and the speaking state correct answer rate were 100%.

### Comparative Example 4

In Comparative Example 4, as illustrated in FIG. 4 (Comparative Example 4), a boundary line (the same boundary line as that in Comparative Example 2) having an inflection point in the front-rear direction is set such that the ratio of the number of people in a first group to the group W is 0.21, and the group W is divided into the first group X and a second group in the right-left direction. Furthermore, people closest to the boundary line are extracted from the first group X and the second group, and a boundary group M along the set boundary line is selected. In FIG. 4 (Comparative Example 4), the boundary group M is illustrated in gray.

In the example illustrated in FIG. 4 (Comparative Example 4), the group W illustrated in the example A in FIG. 2 is exemplified, but each of the groups W illustrated in the examples B to L in FIG. 2 is also divided in a similar manner and a boundary group M is selected in each of the examples B to L in FIG. 2.

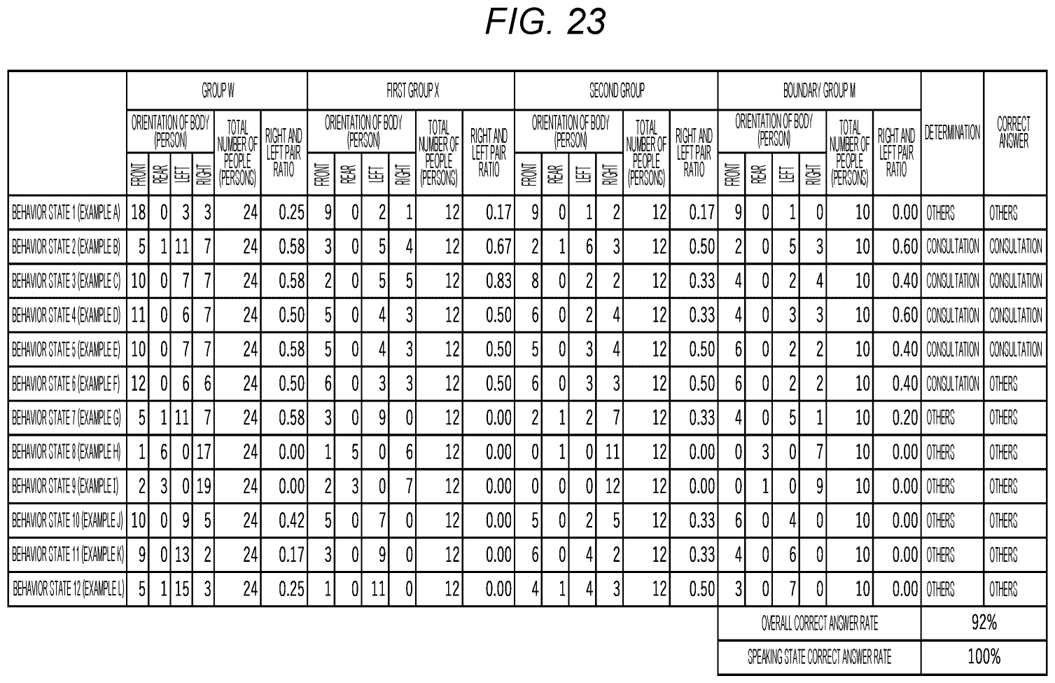

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 22 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 22.

As is understood from comparison between the item of “determination” and the item of “correct answer” in the table illustrated in FIG. 22, the determination results for the behavior state 6 (example F), the behavior state 7 (example G), and the behavior state 10 (example J) are different from the actual behavior states. Therefore, the overall correct answer rate was 75%. Furthermore, since two incorrect determinations were made for the group W in the “speaking state” illustrated in the examples G to L in FIG. 2, the speaking state correct answer rate was 67%.

### Example 12

In Example 12, as illustrated in FIG. 5 (Example 12), a boundary line (the same boundary line as that in Example 5) having an inflection point in the front-rear direction is set such that the ratio of the number of people in a first group to the number of people in the group W is 0.5, and the group W is divided into the first group and a second group in the right-left direction. Furthermore, people closest to the boundary line are extracted from the first group X and the second group, and a boundary group M along the set boundary line is selected. In FIG. 5 (Example 12), the boundary group M is illustrated in gray.

Although the group W illustrated in the example A in FIG. 2 is exemplified in the example in FIG. 5 (Example 12), each of the groups W illustrated in the examples B to L in FIG. 2 is also divided in a similar manner and a boundary group M is selected in each of the examples B to L in FIG. 2.

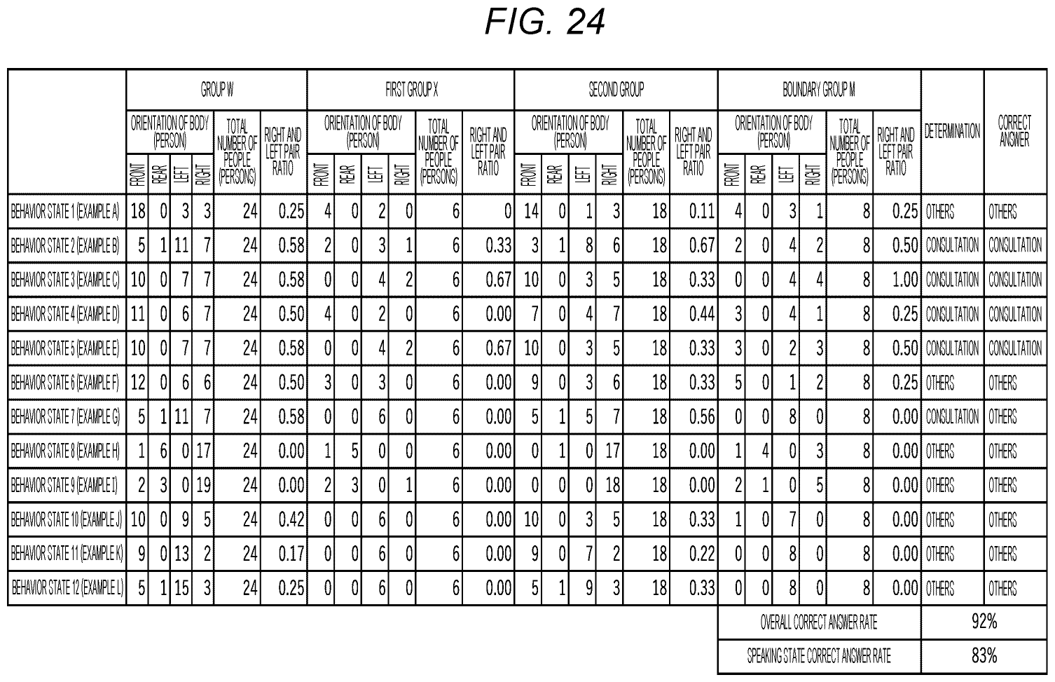

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 23 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 23.

As is understood from comparison between the item of “determination” and the item of “correct answer” in the table illustrated in FIG. 23, only the determination result for the behavior state 6 (example F) is different from the actual behavior state. Therefore, the overall correct answer rate was 92%. In addition, no erroneous determination was made for the group W in the “speaking state” illustrated in the examples G to L in FIG. 2, and the speaking state correct answer rate was 100%.

### Example 13

In Example 13, as illustrated in FIG. 5 (Example 13), a boundary line (the same boundary line as that in Example 6) having an inflection point in the front-rear direction is set such that the ratio of the number of people in a first group to the number of people in the group W is 0.25, and the group W is divided into the first group and a second group in the right-left direction. Furthermore, people closest to the boundary line are extracted from the first group X and the second group, and a boundary group M along the set boundary line is selected. In FIG. 5 (Example 13), the boundary group M is illustrated in gray.

Although the group W illustrated in the example A in FIG. 2 is exemplified in the example in FIG. 5 (Example 13), each of the groups W illustrated in the examples B to L in FIG. 2 is also divided in a similar manner and a boundary group M is selected in each of the examples B to L in FIG. 2.

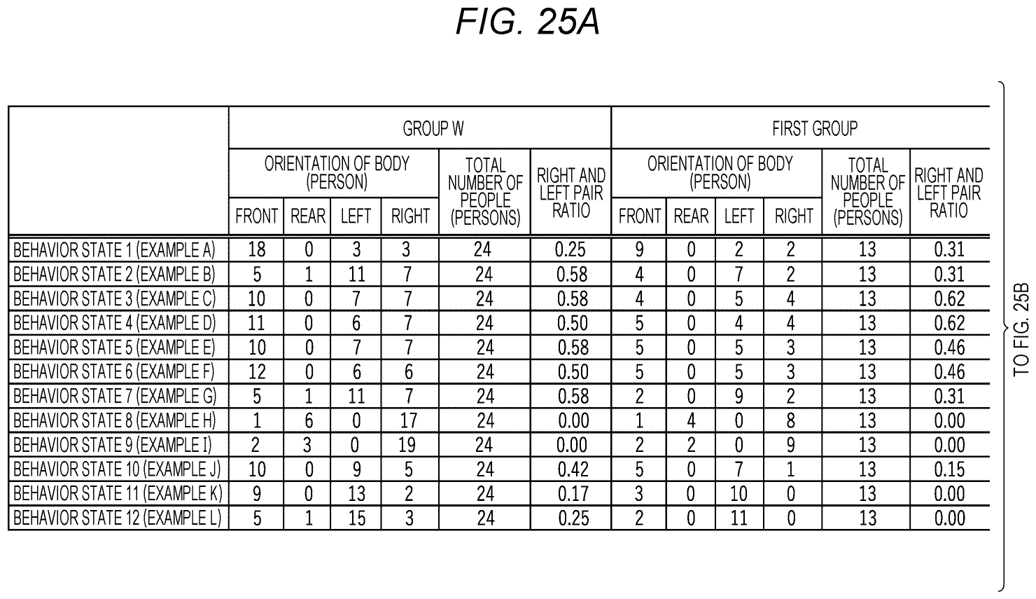

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIG. 24 is a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIG. 24.

As is understood from comparison between the item of “determination” and the item of “correct answer” in the table illustrated in FIG. 24, only the determination result for the behavior state 7 (example G) is different from the actual behavior state. Therefore, the overall correct answer rate was 92%. In addition, since one erroneous determination was made for the group W in the “speaking state” illustrated in the examples G to L in FIG. 2, the speaking state correct answer rate was 83%.

### Example 14

In Example 14, as illustrated in FIG. 5 (Example 14), a boundary line (the same boundary line as that in Example 7) having an inflection point in the front-rear direction is set such that the ratio of the number of people in a first group to the group W is 0.54, and the group W is divided into the first group and a second group in the right-left direction. Furthermore, people closest to the boundary line are extracted from the first group X and the second group, and a boundary group M along the set boundary line is selected. In FIG. 5 (Example 14), the boundary group M is illustrated in gray.

In the example illustrated in FIG. 5 (Example 14), the group W illustrated in the example A in FIG. 2 is exemplified, but each of the groups W illustrated in the examples B to L in FIG. 2 is also divided in a similar manner and a boundary group M is selected in each of the examples B to L in FIG. 2.

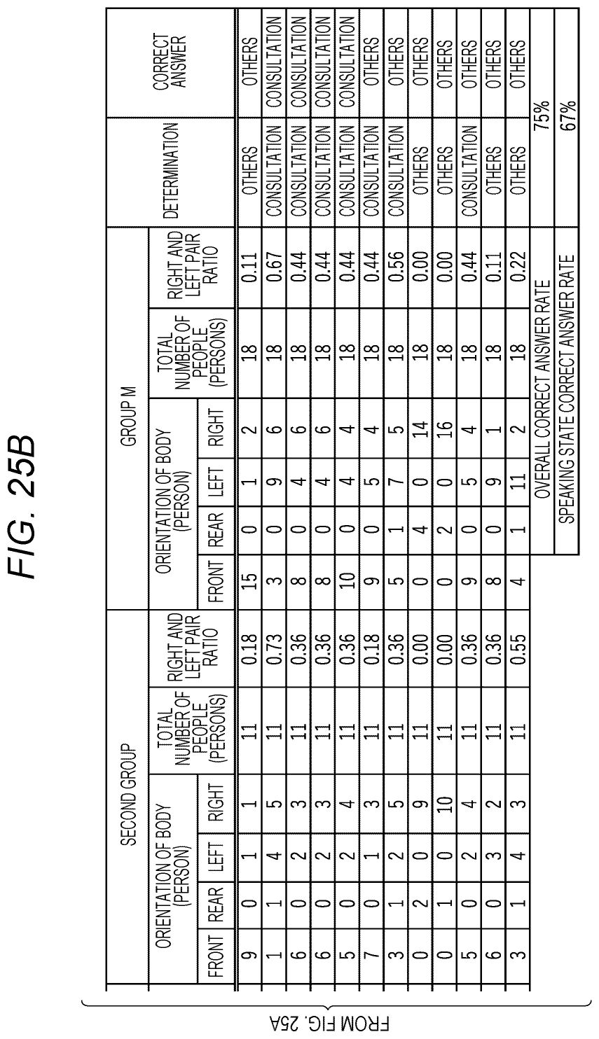

Then, as in Example 8, regarding each of the groups W illustrated in the examples A to L in FIG. 2, the number of participants belonging to each of the groups, the number of participants facing in each of the front, rear, left, and right directions, and the right and left pair ratio were examined for each of the group W, the first group X, the second group, and the boundary group M. FIGS. 25A and 25B are a table illustrating the results.

Next, as in Example 8, it was determined whether the behavior state of the group W was the “consultation state” or the “others” other than the “consultation state” from the right and left pair ratios obtained for the group W, the first group X, the second group, and the boundary group M. The determination was made in accordance with the evaluation criterion 2 illustrated in FIG. 7. The determination results are also illustrated in the table of FIGS. 25A and 25B.

As is understood from comparison between the item of “determination” and the item of “correct answer” in the table illustrated in FIGS. 25A and 25B, the determination results for the behavior state 6 (example F), the behavior state 7 (example G), and the behavior state 10 (example J) are different from the actual behavior states. Therefore, the overall correct answer rate was 75%. Furthermore, since two incorrect determinations were made for the group W in the “speaking state” illustrated in the examples G to L in FIG. 2, the speaking state correct answer rate was 67%.

### Comparative Example 5

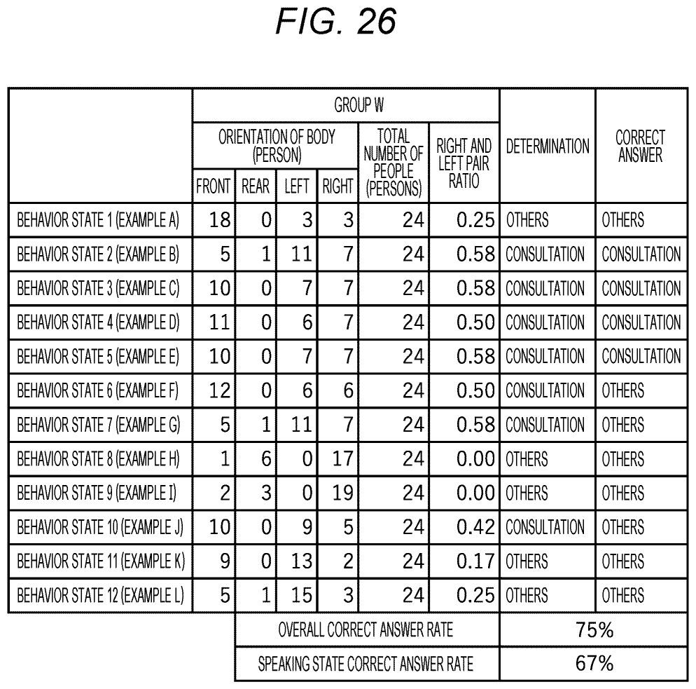

In Comparative Example 5, the number of participants belonging to the group W, the number of participants facing in each of the front, rear, left, and right directions, and the right and left pair ratio were examined in the same manner as in Example 1 without dividing the group W of 24 participants illustrated in each of the examples A to L illustrated in FIG. 2. FIG. 26 is a table illustrating the results.

Next, as in Example 1, for each of the groups W illustrated in the examples A to L in FIG. 2, it was determined whether the behavior state of the group W was the “consultation state” or the “others” other than the “consultation state” from the right and left pair ratios in accordance with the evaluation criterion 1 illustrated in FIG. 6. When the evaluation criterion 1 was used, the right and left pair ratio of the first group X was set to the same value as the right and left pair ratio of the group W, and the right and left pair ratio of the second group was set to 0. The determination results are also illustrated in the table of FIG. 26.

As is understood from comparison between the item of “determination” and the item of “correct answer” in the table illustrated in FIG. 26, the determination results for the behavior state 6 (example F), the behavior state 7 (example G), and the behavior state 10 (example J) are different from the actual behavior states. Therefore, the overall correct answer rate was 75%. Furthermore, since two incorrect determinations were made for the group W in the “speaking state” illustrated in the examples G to L in FIG. 2, the speaking state correct answer rate was 67%.

### Comparative Example 6

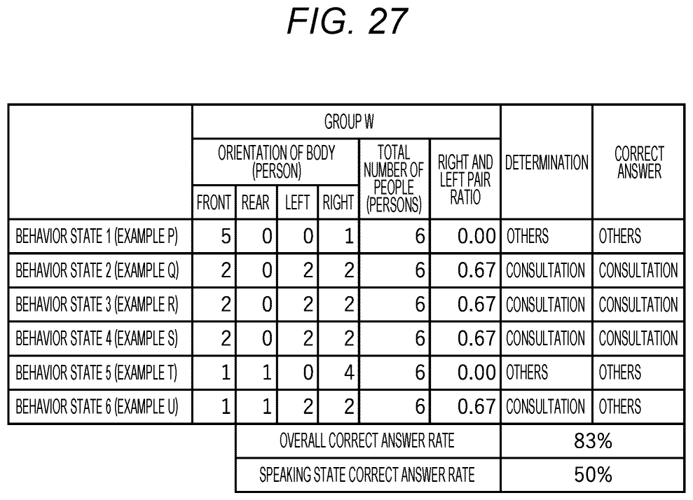

In Comparative Example 6, the number of participants belonging to the group W, the number of participants facing in each of the front, rear, left, and right directions, and the right and left pair ratio were examined in the same manner as in Example 1 without dividing the group W of 6 participants illustrated in the examples P to U in FIG. 3. FIG. 27 is a table illustrating the results.

Next, as in Example 1, for each of the groups W illustrated in the examples P to U in FIG. 3, it was determined whether the behavior state of the group W was the “consultation state” or the “others” other than the “consultation state” from the right and left pair ratios in accordance with the evaluation criterion 1 illustrated in FIG. 6. When the evaluation criterion 1 was used, the right and left pair ratio of the first group X was set to the same value as the right and left pair ratio of the group W, and the right and left pair ratio of the second group was set to 0. The determination results are also illustrated in the table of FIG. 27.

As is understood from comparison between the item of “determination” and the item of “correct answer” in the table illustrated in FIG. 27, the determination result for the behavior state 6 (example U) is different from the actual behavior state. Therefore, the overall correct answer rate was 83%. Further, for the group W in the “speaking state” illustrated in each of the examples T and U in FIG. 3, since one erroneous determination was made, the speaking state correct answer rate was 50%.

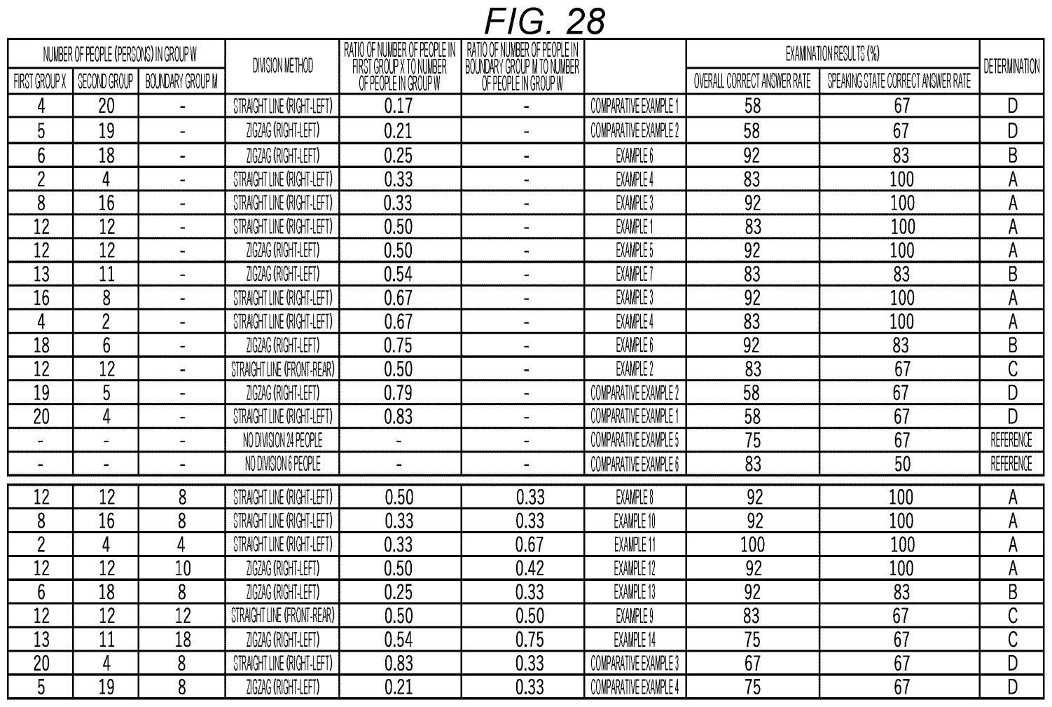

FIG. 28 is a table summarizing the results of the above-described Examples and Comparative Examples. The symbols D, C, B, and A illustrated in the item of determination in FIG. 28 indicate that the determination accuracy becomes better in this order, and therefore, A indicates the best accuracy.

### Evaluation in Case Where Boundary Group M is Not Set

The overall correct answer rate of 75% and the speaking state correct answer rate of 67% in Comparative Example 5 in a case where the group X of 24 people is not divided, and the overall correct answer rate of 83% and the speaking state correct answer rate of 50% in Comparative Example 6 in a case where the group X of 6 people is not divided are set as reference values.

As is understood from FIG. 28, in each of Examples 1 to 7 in which the ratio x/w of the number of people in the first group X to the number of people in the group W is 0.23≤x/w≤0.77, both the overall correct answer rate and the speaking state correct answer rate exceed the reference values. Alternatively, even in a case where one of the overall correct answer rate and the speaking state correct answer rate is equivalent to the reference value, the other exceeds the reference value. Therefore, it was confirmed that the determination of the behavior state was performed with high accuracy.

Furthermore, the determination accuracy is lower in Example 2 in which the group W is divided into the first group and the second group in the front-rear direction than in Examples 1 and 3 to 7 in which the group W is divided into the first group and the second group in the right-left direction. Therefore, it is understood that although the group W may be divided into the first group and the second group in the front-rear direction, it is more desirable that the group W is divided in the right-left direction.

It is also found that highly accurate determination is possible when the total number of people in the group W is desirably 6 or more.

The reason why the accuracy of determining the behavior state of the group X is improved by obtaining the group X by the division such that the ratio x/w of the number of people in the first group X to the number of people in the group W satisfies 0.23≤x/w≤0.77 is presumed as follows.

That is, in a case where the participants face each other on the left and right sides, it is considered that the number of people or the ratio of the number of people facing the left direction and the right direction is substantially the same in the first group and the second group. On the other hand, in a state where the participants face toward the speaker, deviation occurs in the numbers of people or the ratio of the numbers of people facing the left direction and the right direction in the first group and the second group. Therefore, since a difference occurs in data between a case where the participants face each other and a case where the participants face the speaker, it is possible to distinguish between the “consultation state” and the “speaking state”, and it is conceivable that the “consultation state” is appropriately evaluated.

### Evaluation in Case Where Boundary Group M is Selected

From the results of Examples 8 to 14 in which the boundary group M defined in 0.33≤m/w≤0.75 was selected, it can be understood that the determination of the behavior state of the group W can be performed with high accuracy. Note that the number m of people in the boundary group M is preferably smaller than the number of people in each of the first group and the second group.

### Others

By the way, the behavior state of the group W is not always constant but changes with the passage of time. For this reason, it is desirable to adopt a configuration in which the image capturing apparatus 2 continuously captures an image of the group W, the information processing apparatus 1 determines the behavior state at regular time intervals, and results of the determination are recorded in the storage unit 13. Alternatively, it is desirable that the results of the determination can be output to the display device 14, a printer (not illustrated), an external device, or the like.

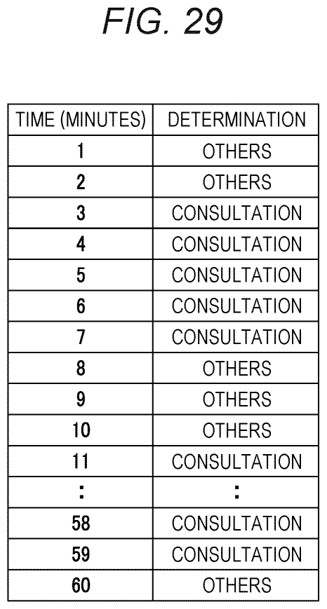

An example of time-series output results is illustrated in FIG. 29. In the example illustrated in FIG. 29, it is determined whether the group X is in the “consultation state” or the “others” every minute. In this way, since the determination of the behavior state is performed in time series, it is possible to grasp the behavior state of each participant in more detail.

Furthermore, data such as the number of people in each of the group W, the first group X, the second group, and the boundary group M, the ratio x/w of the number of people in the first group X to the number of people in the group W, the ratio m/w of the number of people in the boundary group M to the number of people in the group W, the number of people facing in each direction in each group, the right and left pair ratio in each group, and the determination result of the behavior state of each group may be accumulated for machine learning. In this case, data having the same conditions as those of the group W to be determined is searched for from among the accumulated data, which is advantageous in that, for example, the behavior state can be easily determined.

Although the one embodiment of the present invention has been described above, the present invention is not limited to the above-described embodiment.

For example, the group W is divided into the first group X and the second group, but may be divided into three, four, or more groups. Also in this case, the information processing apparatus 1 may obtain the right and left pair ratio in each group, and determine the behavior state of the group X based on an evaluation criterion corresponding to the number of divided groups. Furthermore, in a case where the group W is divided into three or more parts and a boundary group M is selected, the boundary group M may be selected for all boundary lines or only for some of the boundary lines.

In addition, in the plurality of divided groups, it is preferable that there is no overlap of people, but there may be overlap as long as the ratio of the number of people who overlap in two or more divided groups to the number of people in the group W is 10% or less. More preferably, the ratio of the number of people who overlap in two or more divided groups to the number of people in the group W is 5% or less, and most preferably there is no overlap.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A non-transitory recording medium storing a computer readable program, the computer readable program being a behavior state determination program for determining a behavior state of a group of people present in a predetermined space, the behavior state determination program causing a computer to execute:
dividing the group into a plurality of groups including at least a first group and a second group so as to satisfy the following relational formula [1]; extracting state information regarding each person in at least the first group and the second group divided in the dividing; and
determining the behavior state of the group by comparing the state information extracted in the extracting with evaluation criterion information, 0.23≤x/w≤0.77 *** [1], where x is the number of people in the first group, and w is the total number of people in the space.

2. The non-transitory recording medium according to claim 1, wherein the computer divides the group of people standing or sitting side by side while facing forward into groups in a right-left direction of the space.

3. The non-transitory recording medium according to claim 1, wherein the state information is information regarding any of orientations of faces of the people, orientations of bodies of the people, and directions of lines of sight of the people.

4. The non-transitory recording medium according to claim 3, wherein the orientations of the faces of the people, the orientations of the bodies of the people, and the directions of the lines of sight of the people are any of front, rear, left, and right directions.

5. The non-transitory recording medium according to claim 1, wherein, in a boundary region between adjacent groups after the division, the computer executes:
selecting a boundary group so as to satisfy the following relational formula [2];
extracting state information regarding each person in the boundary group; and
determining the behavior state of the group based on the extracted state information regarding each person in the boundary group,
0.33≤m/w≤0.75 *** [2]where m is the number of people in the boundary group, and w is the total number of people in the space.

6. The non-transitory recording medium according to claim 1, wherein the computer acquires position information of the people in the space from an image captured by an image capturing apparatus, or by a position information acquiring apparatus.

7. The non-transitory recording medium according to claim 1, wherein the total number of people in the space is 6 or more.

8. The non-transitory recording medium according to claim 1, wherein the evaluation criterion information is information in which any threshold is set for a minimum value obtained by comparing the number of people in one direction with the number of people in the opposite direction or by comparing a ratio of the number of people in one direction to the total number of people in the space with a ratio of the number of people in the opposite direction to the total number of people in the space.

9. The non-transitory recording medium according to claim 1, wherein the computer determines the behavior state of the group by performing machine learning of state information regarding people belonging to each group or information regarding a ratio of the number of people in each posture to the total number of people in the space.

10. The non-transitory recording medium according to claim 1, wherein the computer determines the behavior state of the group at predetermined time intervals.

11. The non-transitory recording medium according to claim 1, wherein the computer outputs a result of the determined behavior state of the group.

12. A behavior state determination system for determining a behavior state of a group of people present in a predetermined space, the behavior state determination system dividing the group into a plurality of groups including at least a first group and a second group so as to satisfy the following relational formula [1], extracting state information regarding each person in at least the first group and the second group divided in the dividing, and determining the behavior state of the group by comparing the extracted state information with evaluation criterion information, 0.23≤X/W≤0.77 *** [1], where X is the number of people in the first group, and W is the total number of people in the space.

13. A behavior state determination method for determining a behavior state of a group of people present in a predetermined space by a behavior state determination system, the behavior state determination method comprising:
dividing the group into a plurality of groups including at least a first group and a second group so as to satisfy the following relational formula [1];
extracting state information regarding each person in at least the first group and the second group divided in the dividing; and
determining the behavior state of the group by comparing the extracted state information with evaluation criterion information, 0.23≤X/W≤0.77 *** [1], where X is the number of people in the first group, and W is the total number of people in the space.
